(19) United States
(12) Patent Application Publication
(10) Pub. No.: US 2009/0154504 A1
(43) Pub. Date: Jun. 18, 2009

(54) Laser Processing Apparatus, Laser Processing Method, and Method For Making Settings For Laser Processing Apparatus

(75) Inventors: Masao Sato, Osaka (JP); Hideki Yamakawa, Osaka (JP)

Correspondence Address: KILYK & BOWERSOX, P.L.L.C., 400 HOLIDAY COURT, SUITE 102, WARRENTON, VA, 20186, US

(73) Assignee: Keyence Corporation, Osaka (JP)

(21) Appl. No.: 12/270,081

(22) Filed: Nov. 13, 2008

(30) Foreign Application Priority Data
Dec. 14, 2007 (JP) 2007-323686

(51) Int. Cl. H01S 3/101; H01S 3/11

(52) U.S. Cl. 372/10; 372/24

(57) ABSTRACT

It is an object to enable easily adjusting a focus position for coping with thermal lens effects. There is provided a laser-light scanning portion including a Z-axis scanner capable of adjusting the focus position of laser light in the direction of the optical axis, an X-axis scanner and a Y-axis scanner. Further, there are provided a laser driving control portion for controlling a laser oscillation portion and the laser-light scanning portion, a processing-condition setting portion for setting a laser-light outputting condition and a processing pattern as processing conditions for processing in a desired processing pattern, and an amount-of-correction identification section for identifying, as an amount of focus-position correction, the deviation of the focus position in the direction of the optical axis which is caused by thermal lens effects induced based on the laser-light outputting condition set by the processing-condition setting portion. During irradiation of the laser light, the laser driving control portion scans the laser light, in such a way as to add the amount of focus-position correction identified by the amount-of-correction identification section to the processing condition set by the processing-condition setting portion.

### CROSS-REFERENCE TO RELATED APPLICATIONS

The present application claims foreign priority based on Japanese Patent Application No. 2007-323686, filed Dec. 14, 2007, the contents of which is incorporated herein by reference.

### BACKGROUND OF THE INVENTION

1. Field of the Invention

The present invention relates to a laser processing apparatus for directing laser light to a to-be-processed target for performing processing such as printing, such as a laser marking apparatus, a laser processing method and a method for making settings for a laser processing apparatus.

2. Background Art

Laser processing apparatuses are adapted to scan laser light over a predetermined area for directing the laser light to the surface of a to-be-processed target (work) such as a component and product for performing processing such as printing and marking thereon. FIG. 22 illustrates an exemplary structure of a laser processing apparatus. The laser processing apparatus illustrated in the figure includes a laser control portion 1, a laser output portion 2 and an input portion 3. The laser control portion 1 includes a laser excitation portion 6 which generates excitation light, and the excitation light is directed to a laser medium 8 constituting an oscillator in a laser oscillation portion 50 in the laser output portion 2, thereby inducing laser oscillation. The oscillating laser light is emitted from the emission end surface of the laser medium 8, then is expanded in beam diameter by a beam expander 53, then is reflected by an optical member such as a mirror as required and then is directed to a laser-light scanning portion 9. The laser-light scanning portion 9 causes the laser light L to be reflected by a Galvano mirror or the like to be polarized in a desired direction. Further, under the laser-light scanning portion 9, there is provided a light condenser portion 15. The light condenser portion 15 is constituted by a condenser lens for condensing the laser light such that it is directed to a work area and is constituted by an fθ lens. The laser light L outputted from the light condenser portion 15 is scanned over the surface of a work WK, thereby performing processing such as printing thereon.

FIG. 23 illustrates details of the laser-light scanning portion 9 for scanning the output laser light over the work. The laser-light scanning portion 9 includes X-axis and Y-axis scanners 14a and 14b constituting a pair of Galvano mirrors, and Galvano motors 51a and 51b for rotating the Galvano mirrors secured to respective rotational shafts. The X-axis and Y-axis scanners 14a and 14b are placed such that they take attitudes which are orthogonal to each other, as illustrated in FIG. 23, which enables scanning the laser light by reflecting it in the X direction and the Y direction.

Further, the laser processing apparatus illustrated in FIG. 23 is additionally provided with a Z-axis scanner 14c, which enables adjusting the focus position in the direction of the optical axis. This enables performing three-dimensional processing by relatively changing the focus position of the laser light in the height direction, namely the direction of the Z axis, in addition to processing within a two-dimensional plane. The Z-axis scanner 14c includes an incidence lens facing to the laser oscillation portion and an emission lens facing to the laser emission side, wherein the lenses can be slid by driving motors and the like for changing the distance between the lenses, thereby adjusting the focus position, namely the working distance (WD) in the heighwise direction. Such a laser processing apparatus is adapted to enable adjustments of its output, by making settings of the laser power to be emitted from the laser oscillator, the frequency and the duty ratio of a Q switch and the like (for example, Japanese Unexamined Patent Publication No. 2000-202655).

### SUMMARY OF THE INVENTION

On the other hand, laser crystals induce the phenomenon of deformations of the end surfaces of the crystals, which is called thermal lens effects due to heat, which induces the problem of changes of the focal distance. Such thermal lens effects are a phenomenon in which laser crystals are locally raised in temperature due to laser irradiation, thereby inducing refractive-index distributions. For example, the solid laser mediums in solid lasers such as YAG lasers and YVO₄ lasers induce imaginary lenses based on the refractive-index distributions within the crystals, namely thermal lenses, depending on the laser power, the frequency of the Q switch and the duty ratio of the Q switch. Such thermal lens effects are varied in degree, depending on the amount of heat retained within the laser oscillator, and the focal distance is changed depending on the degree of thermal lens effects. If the focal distance is changed, this will prevent the laser processing apparatus designed to perform proper processing with the original focus position from performing original processing, thereby degrading the processing quality. In order to avoid this, it is necessary to manually adjust the working distance between the to-be-processed target and the laser processing apparatus, in such a way as to correct the focus position in consideration of the thermal lens effects. Unfortunately, the amount of heat retained within the laser oscillator which affects the thermal lens effects depends on the values set for the laser oscillator. Therefore, if the set values are changed, the focal distance is also changed. Accordingly, every time the laser processing conditions are changed, there is a need for resetting the working distance, which has forced users to perform extremely complicated adjustment operations. Particularly, most of laser processing apparatus are adapted to be capable of changing the conditions such as the laser power, the frequency and the duty ratio of the Q switch, on a block-by-block basis, within to-be-processed areas. This may induce different degrees of thermal lens effects in the respective processing blocks, thereby resulting in the problem of difficulty in performing processing on block-by-block basis with the same processing quality.

The present invention was made in order to overcome the conventional problems. It is an object of the present invention to provide a laser processing apparatus, a laser processing method and a method for making settings for a laser processing apparatus which enable adjustments of the focus position for coping with thermal lens effects.

A laser processing apparatus according to a first aspect of the present invention is a laser processing apparatus capable of directing laser light to a to-be-processed surface for performing processing in a desired processing pattern, the laser processing apparatus including:

a laser oscillation portion for generating laser light; a laser-light scanning portion for scanning the laser light emitted from the laser oscillation portion within a work area, the laser-light scanning portion including a Z-axis scanner including an incidence lens and an emission lens and being capable of changing the distance between the incidence lens and the emission lens along their optical axis for adjusting the focus position of the laser light in the direction of the optical axis at a state where the optical axes of the incidence lens and the emission lens are coincident with the optical axis of the laser light emitted from the laser oscillation portion, and an X-axis scanner and a Y-axis scanner for scanning the laser light passed through the Z-axis scanner in the direction of the X axis and in the direction of the Y axis; a laser driving control portion for controlling the laser oscillation portion and the laser-light scanning portion; a processing-condition setting portion for setting a laser-light outputting condition and a processing pattern, as processing conditions for processing in a desired processing pattern; and an amount-of-correction identification section for identifying, as an amount of focus-position correction, the deviation of the focus position in the direction of the optical axis which is caused by thermal lens effects induced depending on the laser-light outputting condition set by the processing-condition setting portion; wherein, during irradiation of the laser light, the laser driving control portion causes scanning of the laser light, in such a way as to add the amount of focus-position correction identified by the amount-of-correction identification section to the processing conditions set by the processing-condition setting portion.

This enables correcting the deviation in the direction of the optical axis which is caused by thermal lens effects, through the Z-axis scanner capable of realizing three-dimensional processing. This can eliminate setting operations for physically adjusting the focus position in the laser processing apparatus, thereby realizing a laser processing apparatus with excellent usability which can facilitate making initial settings.

A laser processing apparatus according to a second aspect of the present invention further includes a Q switch for causing pulsed oscillation of the laser light, wherein the processing-condition setting portion is capable of setting at least one of the laser power, the frequency of the Q switch, and the ON/OFF duty ratio of the Q switch, as a laser-light outputting condition, the amount-of-correction identification section determines that the focal distance is increased and, thus, sets an amount of focus-position correction in the direction of the optical axis for coping with thermal lens effects in such a direction as to make the focus position closer, when the processing-condition setting portion makes settings in a direction such that the laser power is increased the frequency of the Q switch is decreased or the ON/OFF duty ratio is increased, and the amount-of-correction identification section determines that the focal distance is decreased and, thus, sets an amount of focus-position correction in such a direction as to make the focus position more distant, when the processing-condition setting portion makes settings in a direction such that the laser power is decreased, the frequency of the Q switch is increased or the ON/OFF duty ratio is decreased.

Consequently, the amount-of-correction identification section can correct the focus position to a proper focus position based on the laser-light outputting condition. More specifically, when the focal distance is extended, the amount of focus-position correction is set in such a way as to make the focus position closer, but, when the focal distance is shortened, the amount of focus-position correction is set in such a way as to make the focus position more distant.

A laser processing apparatus according to a third aspect of the present invention further includes an amount-of-correction storage section for preliminarily storing amounts of focus-position correction in the direction of the optical axis for coping with thermal lens effects, in association with laser-light outputting conditions, wherein the amount-of-correction identification section identifies an amount of focus-position correction corresponding to the set laser-light outputting condition, by reading it from the amount-of-correction storage section.

This enables easily identifying an amount of focus-position correction with the amount-of-correction identification section, which can reduce the load of the processing by the amount-of-correction identification section, thereby realizing speed-up.

Further, in a laser processing apparatus according to a fourth aspect of the present invention, the amount-of-correction identification section identifies an amount of focus-position correction in the direction of the optical axis for coping with thermal lens effects, through calculations based on a preset calculation equation.

This enables properly determining an amount of focus-position correction, without using a table and the like.

Further, in a laser processing apparatus according to a fifth aspect of the present invention, the processing-condition setting portion is capable of setting an amount of defocusing by which the focus position of the laser light is purposely deviated, and the amount-of-correction identification section identifies an amount of focus-position correction in the direction of the optical axis for coping with thermal lens effects, based on the set amount of defocusing.

This enables properly alleviating the influence of thermal lens effects, even if an amount of defocusing is set.

Further, in a laser processing apparatus according to a sixth aspect of the present invention, the processing-condition setting portion is capable of setting one or more three-dimensional processing patterns for a to-be-processing surface for different conditions, as processing conditions.

This enables correcting thermal lens effects, using the focus-position adjusting function of the laser processing apparatus capable of three-dimensional processing. Further, even when a plurality of different processing patterns are set, the amount of focus-position movement can be adjusted for each processing pattern, which realizes high-quality processing capable of maintaining constant processing quality for respective positions.

Further, in a laser processing apparatus according to a seventh aspect of the present invention, in processing with the plurality of different patterns, the laser driving control portion is capable of setting a delay time for delaying the start of outputting of the laser light, after a command for an operation is generated to the Z-axis scanner until the Z-axis scanner will have completed the operation commanded by the command for the operation, based on the laser-light outputting condition and/or the processing patterns.

This enables performing a delay operation for preventing the laser light from being outputted, until the movement of the Z-axis scanner to the focus position is completed during processing. Accordingly, even though the Z-axis scanner having a lower response speed is used, it is possible to prevent the degradation of the processing accuracy due to irradiation of the laser light before the Z-axis scanner has been moved to the correct position. This can maintain the processing quality.

Further, in a laser processing apparatus according to an eighth aspect of the present invention, when the plurality of processing patterns are set in association with different processing conditions, the laser driving control portion adjusts the delay time, according to the previous processing pattern and the amount of focus-position correction for the previous processing pattern.

Particularly, when the plurality of processing patterns are set in association with different processing conditions, the operating time of the Z-axis scanner for a processing pattern is varied depending on the position of the Z-axis scanner at the time of the end of processing for the previous processing pattern. Accordingly, by properly setting the delay time in consideration of this fact, it is possible to perform a delay operation with high efficiency.

Further, in a laser processing apparatus according to a ninth aspect of the present invention, the processing conditions set by the processing-condition setting portion include a parameter relating to the elapsed time, and the amount-of-correction identification section identifies an amount of focus-position correction based on the parameter relating to the elapsed time.

Consequently, even when it takes a long time period for bringing thermal lens effects into a thermal equilibrium state after the laser power and the frequency of the Q switch are changed, it is possible to change the amount of focus-position correction with time for coping therewith.

Further, a laser processing apparatus according to a tenth aspect of the present invention is a laser processing apparatus capable of directing laser light to a to-be-processed surface for performing processing in a desired processing pattern, the laser processing apparatus including: a light source; a laser medium which is placed in a resonator for laser light and is excited by the light-source light from the light source to generate laser light; a Q switch which is placed on the optical axis of the laser light emitted from the laser medium within the resonator for causing pulsed oscillation of the laser light; a focus-position adjustment section capable of adjusting the focus position of the laser light emitted from the Q switch in the direction of the optical axis; a laser-light two-dimensional scanning system for scanning, in a two-dimensional manner, the laser light emitted from the focus-position adjustment section; a processing-condition setting portion for setting at least one of the power of the laser light emitted from the Q switch, the frequency of the Q switch and the ON/OFF duty ratio of the Q switch; an amount-of-correction identification section for identifying, as an amount of focus-position correction, the deviation of the focus position in the direction of the optical axis which is caused by induced thermal lens effects, based on the settings made by the processing-condition setting portion; and a laser driving control portion for controlling the focus-position adjustment section in such a way as to adjust the focus position, based on the amount of focus-position correction identified by the amount-of-correction identification section.

This enables performing processing by adjusting the focus position in such a way as to offset the influence of thermal lens effects. This can eliminate adjustment operations for coping with thermal lens effects, thereby extremely reducing the burden for adjusting installation operations.

Further, a laser processing method according to an eleventh aspect of the present invention is a laser processing method for directing laser light to a to-be-processed surface for performing processing in a desired processing pattern, the laser processing method including the steps of: setting a processing pattern and a laser-light outputting condition including at least one of the power of the laser light emitted from the Q switch, the frequency of the Q switch and the ON/OFF duty ratio of the Q switch, as processing conditions for processing in a desired processing pattern; identifying, as an amount of focus-position correction, the deviation of the focus position in the direction of the optical axis which is caused by induced thermal lens effects, based on the laser-light outputting condition which has been set; and performing processing through irradiation of the laser light based on the laser-light outputting condition and the processing pattern which have been set, while adjusting the focus position of the laser light emitted from the Q switch in the direction of the optical axis, based on the identified amount of focus-position correction.

This enables performing processing by adjusting the focus position in such a way as to offset the influence of thermal lens effects. This can eliminate adjustment operations for coping with thermal lens effects, thereby extremely reducing the burden for adjusting installation operations.

Further, a laser processing method according to a twelfth aspect of the present invention is a method for making settings for a laser processing apparatus for directing laser light to a to-be-processed surface for performing processing in a desired processing pattern, the method including the steps of: setting a processing pattern and a laser-light outputting condition including at least one of the power of the laser light emitted from the Q switch, the frequency of the Q switch and the ON/OFF duty ratio of the Q switch, as processing conditions for processing into a desired processing pattern; and identifying the deviation of the focus position in the direction of the optical axis which is caused by induced thermal lens effects based on the set laser-light outputting condition, and setting the focus position corresponding to the processing pattern in such a way as to correct the focus position by using the deviation of the focus position as an amount of focus-position correction, at the time of processing.

This enables corrections according to the deviation of the focus position caused by thermal lens effects which are expected to occur during actual processing, at the time of setting the laser processing condition. As a result, it is possible to eliminate operations for manually adjusting the height of the installed laser processing apparatus and the like for adjusting the working distance, thereby offering the advantage of coping with thermal lens effects extremely easily.

### BRIEF DESCRIPTION OF THE DRAWINGS

FIG. 1 is a block diagram illustrating the structure of a laser processing apparatus according to an embodiment of the present invention;

FIG. 2 is a perspective view illustrating the internal structure of a laser excitation portion in FIG. 1;

FIG. 3 is a perspective view illustrating the structure of a marking head including a laserlight scanning portion in the laser processing apparatus;

FIG. 4 is a perspective view illustrating the same at the back surface thereof;

FIG. 5 is a perspective view illustrating the same at a side surface thereof;

FIGS. 6A and 6B are explanation views illustrating a state where the focus position of laser light from the laser processing apparatus is changed with respect to a work position;

FIG. 7 is a side view illustrating the laser-light scanning portion when the focal distance is increased;

FIG. 8 is a side view illustrating the laser-light scanning portion when the focal distance is decreased;

FIGS. 9A and 9B are a front view and a cross-sectional view illustrating a Z-axis scanner;

FIG. 10 is a block diagram illustrating the system structure of a laser marker capable of three-dimensional printing;

FIG. 11 is a block diagram illustrating a laser processing system;

FIG. 12 is a block diagram illustrating another example of the laser processing system;

FIG. 13 is a block diagram illustrating still another example of the laser processing system;

FIGS. 14A and 14B are image diagrams illustrating an exemplary user-interface screen page of a laser-processing-data setting program, wherein FIG. 14A shows a whole view, and FIG. 14B shows a right part of FIG. 14A, showing a printing-pattern input field 204;

FIGS. 15A and 15B are image diagrams illustrating a screen page for calling up a list of processing blocks, from the screen page of FIGS. 14A and 14B, wherein FIG. 15A shows a whole view, and FIG. 15B shows a right part of FIG. 15A, showing a printing-pattern input field 204;

FIGS. 16A and 16B are image diagrams illustrating an example of a processing-block setting section for setting a plurality of printing blocks, wherein FIG. 16A shows a whole view, and FIG. 16B shows a block-list screen image 217;

FIGS. 17A and 17B are image diagrams illustrating an example of a processing-parameter setting screen page, wherein FIG. 17A shows a whole view, and FIG. 17B shows a right part of FIG. 17A, showing a printing-pattern input field 204;

FIGS. 18A and 18B are image diagrams illustrating an example of a screen page for setting an amount of defocusing, wherein FIG. 18A shows a whole view, and FIG. 18B shows a right part of FIG. 18A, showing a printing-pattern input field 204;

FIG. 19 is a schematic view illustrating a state where thermal lens effects are corrected, wherein FIG. 19 (a) illustrates a state where the focal distance is extended, and FIG. 19 (c) illustrates a state where the focal distance is shortened, with respect to FIG. 19 (b);

FIG. 20 is a functional block diagram illustrating procedures for creating required information at the time of processing;

FIG. 21 is a flow chart illustrating procedures for determining an amount of focus-position correction to be supplied to the Z-axis scanner;

FIG. 22 is a block diagram illustrating the structure of a conventional laser processing apparatus; and

FIG. 23 is a transparent perspective view illustrating a state where an X-axis scanner, a Y-axis scanner and a Z-axis scanner are placed.

### DETAILED DESCRIPTION OF THE PREFERRED EMBODIMENTS

Hereinafter, an embodiment of the present invention will be described, with reference to the drawings. However, in the embodiment which will be described later, there will be exemplified a laser processing apparatus, a laser processing method and a method for making settings for a laser processing apparatus for concretizing the technical concepts of the present invention and, in the present invention, the laser processing apparatus, the laser processing method and the method for making settings for the laser processing apparatus are not limited to those which will be described later. Further, in the present specification, the members defined in the claims are never limited to the members in the embodiment. Particularly, the dimensions, the materials, the shapes and the relative placements of components which will be described in the embodiment are merely illustrative and are not intended to limit the scope of the present invention, unless otherwise specified. Further, the sizes of the members and the positional relationship thereamong which are illustrated in the drawings may be sometimes exaggerated for clarification of the description. Further, in the following description, the same designations and the same reference characters will designate identical or equivalent members, and detailed description thereof will be properly eliminated. Further, as respective components constituting the present invention, a plurality of components can be constituted by a single member such that the single member serves as the plurality of components or, on the contrary, the function of a single member is realized by the plurality of members. Further, contents which will be described in some examples or embodiments can be sometimes utilized in other examples or embodiments or the like.

In the present specification, the laser processing apparatus, a computer connected thereto for operations, control, inputting/outputting, display and other processing, a printer, an external storage device and other peripheral apparatuses are electrically connected to one another for communication thereamong, through, for example, IEEE1394, RS-232x, RS-422, RS-423, RS-485, USB, PS2 which are connected in serial or in parallel or through networks such as 10BASE-T, 100BASE-TX, 1000-BASE-T and the like. The connections thereamong are not limited to physical wired connections, but can be wireless connections and the like utilizing wireless LANs of IEEE802.1x type, OFDM type and the like, radio waves such as Bluetooth (registered trademark), infrared waves, optical communications and the like. Further, as recording mediums for storing processing pattern data and for storing setting and the like, it is possible to use memory cards, magnetic disks, optical disks, optical magnetic disks, semiconductor memories and the like.

In the following embodiment, a laser marker will be described, as an example of the laser processing apparatus which concretizes the present invention. However, the laser processing apparatus described in the present specification can be generally used in laser-applied apparatuses, regardless of its designation. For example, the laser processing apparatus can be suitably used in or for laser oscillators, various types of laser processing apparatuses and laser processing such as drilling, marking, trimming, scribing and surface processing. Also, the laser processing apparatus can be used as laser light sources in other laser application fields, such as light sources for high-density recording/replaying for optical disks such as DVDs and Blu-ray (registered trademark) or light sources for communications. Also the laser processing apparatus can be suitably used in or as printing apparatuses, illumination light sources, light sources for display devices such as displays, and medical apparatuses and the like.

Further, in the present specification, printing will be described as a representative example of processing, but the present invention can be used for various types of processing using laser light, such as melting, exfoliation, surface oxidation, cutting, color changing, as well as printing processing, as described above. Further, the term “printing” will be used based on the concept that it includes the various types of processing, in addition to marking characters, symbols, graphics and the like. Further, in the present specification, the term “processing pattern” will be used, based on the concept that it section katakanas, kanji characters, alphabetical characters, numerical characters, symbols, pictographic characters, icons, logos, barcodes, two-dimensional codes and other graphics, and also section straight lines, curves and other graphics. Particularly, in the present specification, the term “characters” representing characters or symbols section characters which can be read by an optical reading apparatus such as an OCR and is used based on the concept that it includes alphabetical characters, kanji characters, hiraganas, kataganas, numerical characters and symbols. Further, the term “symbols” section barcodes and two-dimensional codes.

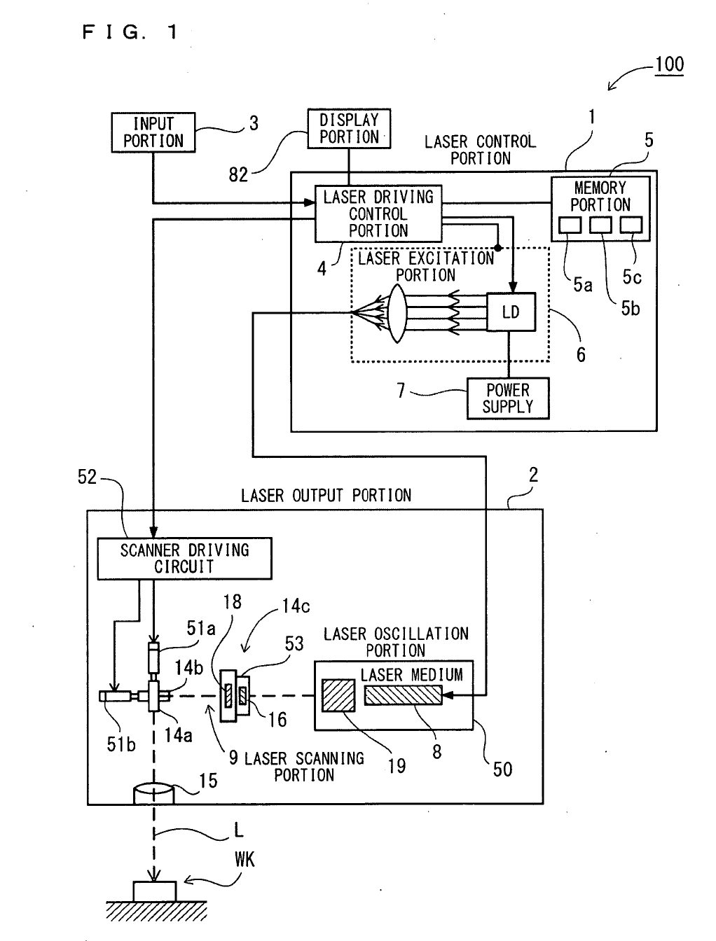

FIG. 1 is a block diagram illustrating the structure of a laser processing apparatus 100. The laser processing apparatus 100 illustrated in the figure includes a laser control portion 1, a laser output portion 2 and an input portion 3.

### (Input Portion 3)

The input portion 3, which is connected to the laser control portion 1, receives inputted settings required for operations of the laser processing apparatus and transmits the settings to the laser control portion 1. The contents of the settings are operating conditions of the laser processing apparatus, the concrete content of printing, and the like. The input portion 3 is an input device such as a key board, a mouse or a console. Further, it is also possible to additionally provide a display portion 82 which enables recognizing the input information inputted through the input portion 3 and displaying the state and the like of the laser control portion 1. The display portion 82 can be constituted by a monitor, such as an LCD or a cathode-ray tube. Further, by utilizing a touch panel system, it is possible to cause the input portion to function as the display portion. This enables making required settings for the laser processing apparatus, through the input portion, without connecting an external computer or the like thereto.

### (Laser Control Portion 1)

The laser control portion 1 includes a laser driving control portion 4, a memory portion 5, a laser excitation portion 6 and a power supply 7. The memory portion 5 holds the contents of various types of settings which have been inputted from the input portion 3. The laser driving control portion 4 controls a laser oscillation portion 50 and a laser-light scanning portion 9. More specifically, the laser driving control portion 4 reads the contents of settings from the memory portion 5 as required and operates the laser excitation portion 6 based on printing signals corresponding to the content of printing for exciting a laser medium 8 in the laser output portion 2. The memory portion 5 can be constituted by a semiconductor memory, such as a RAM or a ROM. Further, the memory portion 5 can be constituted by an insertable/removable semiconductor memory card such as a PC card or an SD card or a memory card such as a card-type hard disk, as well as being incorporated in the laser control portion 1. The memory portion 5 constituted by a memory card is easily rewritable by an external apparatus such as a computer, which enables making settings by writing, in the memory card, the contents of settings made through the computer and then setting the memory card in the laser control portion 1, without connecting the input portion to the laser control portion. Particularly, a semiconductor memory enables reading and writing data therefrom and therein at high speeds and, further, has no mechanically-operated portion and thus has higher strength against vibrations and the like, thereby preventing data erasure accidents due to clashes, which can occur in hard disks.

In the example of FIG. 1, the memory portion 5 includes a setting-information memory 5a, a basic character/line-segment information memory 5b and a decompressed-information memory 5c. The setting-information memory 5a is constituted by a non-volatile memory such as an SRAM or an EEPROM which is backed up by a battery and can hold the content of storage even when the power supply is off. Setting information stored in the setting-information memory 5a includes information about the content of printing, such as the types, the sizes, the positions and the orientations of characters and marks to be printed. Further, the basic character/line-segment information memory 5b is also constituted by a non-volatile memory, such as an SRAM or an EEPROM which is backed up by a battery. The basic character/line-segment information memory 5b stores information about basic characters such as various types of characters and marks to be used in printing and basic line segments (basic character/line-segment information). This basic character/line-segment information can be managed as common data of the content of printing, which can reduce the amounts of respective setting information. Accordingly, when decompressed information is created from the setting information, a reference is made to the basic character/line-segment information stored in the basic character/line-segment information memory 5b. Further, the decompressed-information memory 5c is constituted by a volatile memory such as a DRAM capable of storing a large amount of information with a lower cost, but the content of storage therein is erased when the power supply is off. The decompressed information created from the setting information and the basic character/line-segment information is temporarily stored in the decompressed-information memory 5c and is referred to at the time of printing. The decompressed information is time-sequence data constituted by a plurality of bits and includes line-segment data defining the locus of laser light for printing processing and laser control data for use in controlling ON/OFF of the laser.

Further, the laser driving control portion 4 outputs, to the laser-light scanning portion 9, scanning signals for operating the laser-light scanning portion 9 in the laser output portion 2, in order to scan, over a target (work) WK to be subjected to printing, the oscillating laser light L created by the laser medium 8 for performing set printing. The power supply 7 as a constant voltage source applies a predetermined voltage to the laser excitation portion 6. Printing signals for controlling printing operations are PWM signals, such that the laser light L is changed over between ON and OFF according to the HIGH/LOW of the PWM signals, and each single pulse of the PWM signals corresponds to a single pulse of the oscillating laser light L. The PWM signals can be structured such that the laser intensity is determined based on the duty ratio corresponding to the frequency of the PWM signals, but the PWM signals can be also structured such that the laser intensity is varied according to the scanning speed based on the frequency.

### (Laser Excitation Portion 6)

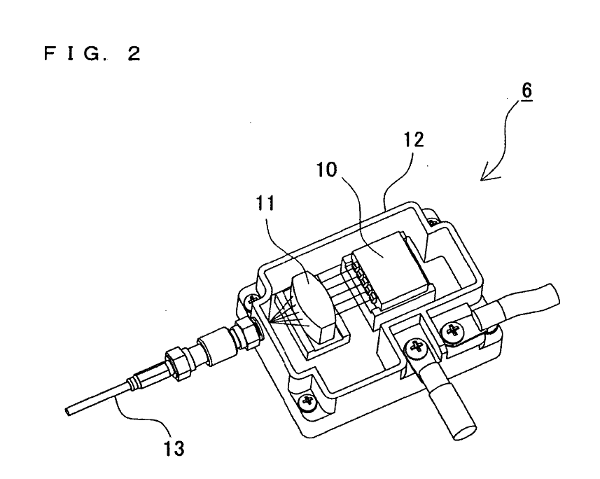

The laser excitation portion 6 includes a laser excitation light source 10 and a laser excitation light-source condenser portion 11 which are optically coupled to each other. FIG. 2 is a perspective view illustrating an example of the internal portion of the laser excitation portion 6. In the laser excitation portion 6 illustrated in the figure, the laser excitation light source 10 and the laser excitation light-source condenser portion 11 are secured to the inside of a laser-excitation-portion casing 12. The laser-excitation-portion casing 12 is made of a metal with excellent heat conductivity such as cupper and, thus, releases heat from the laser excitation light source 10 to the outside with higher efficiently. The laser excitation light source 10 is constituted by semiconductor lasers (Laser Diodes: LDs), excitation lamps or the like. In the example of FIG. 2, there is employed a laser diode array constituted by a plurality of semiconductor laser diode devices which are linearly arranged, such that laser oscillation from the respective devices are outputted in a line shape. The laser oscillation is inputted to an incidence surface of the laser excitation light-source condenser portion 11 and, then, is outputted from an emission surface, as laser excitation light which has been condensed. The laser excitation light-source condenser portion 11 is constituted by a focusing lens or the like. The laser excitation light from the laser excitation light-source condenser portion 11 is inputted to the laser medium 8 in the laser output portion 2 through an optical fiber cable 13 and the like. The laser excitation light source 10, the laser excitation light-source condenser portion 11 and the optical fiber cable 13 are optically coupled to one another through a space or an optical fiber.

### (Laser Output Portion 2)

The laser output portion 2 includes a laser oscillation portion 50. The laser oscillation portion 50 which generates laser light L includes the laser medium 8, an output mirror and a total reflection mirror which are placed oppositely to each other with a predetermined distance interposed therebetween along the optical path of the light emitted through stimulated emission from the laser medium 8, an aperture placed therebetween, a Q switch 19 and the like. The Q switch 19 is placed such that it is faced to one of the end surfaces of the laser medium 8, such that it is positioned on the optical axis of the laser emitted from the laser medium 8. The use of the Q switch 19 enables changing continuous oscillation to high-speed repetition pulsed oscillation with a high peak output value (a peak value). Further, a Q-switch control circuit for creating RF signals to be applied to the Q switch 19 is connected to the Q switch 19. The laser oscillation portion 50 amplifies the light emitted through stimulated emission from the laser medium 8 by multiple reflection between the output mirror and the total reflection mirror, further performs mode selection thereon with the aperture while passing or shutting off the light with a short period through the operation of the Q switch 19 and, further, outputs laser light L through the output mirror. The laser medium 8 is excited by the laser exciting light inputted thereto from the laser excitation portion 6 through the optical fiber cable 13 to cause laser oscillation. A so-called end pumping system is employed with the laser medium 8, wherein the laser medium 8 is excited by the laser exciting light inputted to one end surface of its rod shape and emits laser light L from the other end surface thereof.

### (Laser Medium 8)

In the above-described example, an Nd: YVO₄ crystal with a rod shape is employed as the laser medium 8. Further, the wavelength of the semiconductor laser for exciting the solid laser medium is set to 808 nm, which is equal to the center wavelength of the absorption spectrum of the Nd:YVO₄. However, the present invention is not limited to this example, and it is also possible to employ, as other solid laser mediums, YAG, LiSrF, LiCaF, YLF, NAB, KNP, LNP, NYAB, NPP, GGG and the like which have been doped with rare earth materials, for example. Further, a wavelength conversion device can be employed in combination with the solid laser medium for changing the wavelength of the outputted laser light L to an arbitrary wavelength. Further, the present invention can be also applied to a so-called fiber laser which employs a fiber as an oscillator instead of a solid laser medium which is a bulk. Also, it is possible to employ a wavelength conversion device only for wavelength conversion, without using a solid laser medium, in other words, without constituting a resonator for causing oscillation of laser light. In this case, the wavelength conversion is performed on the output light of the semiconductor laser.

As the wavelength conversion device, it is possible to employ, for example, KTP (KTiPO₄), organic nonlinear optical materials, other inorganic nonlinear optical materials such as KN (KNbO₃), KAP (KAsPO₄), BBO (β-BaB₂O₄), LBO(LiB₃O₅), or bulk-type polarization inversion devices (LiNbO₃ (Periodically Polled Lithium Niobate: PPLN), LiTaO₃ and the like). Also, it is possible to employ an excitation light-source semiconductor laser for an up-conversion laser employing a fluoride fiber which has been doped with rare earth materials such as Ho, Er, Tm, Sm and Nd. As described above, it is possible to employ various types of laser sources, as required, in the present embodiment.

Furthermore, the laser oscillation portion 50 can employ a gas laser which employs, as a medium, gas such as CO₂, helium-neon, argon or nitrogen, as well as a solid laser. For example, in the case of employing a carbon dioxide gas laser, the inside of the laser oscillation portion is filled with a carbon dioxide gas (CO₂), and the laser oscillation portion incorporates electrodes and excites the carbon dioxide gas inside thereof for causing laser oscillation based on the printing signals from the laser control portion.

### (Bi-Directional Excitation System)

As a structure for exciting the solid laser medium, it is possible to employ a single-directional excitation system based on so-called end pumping which inputs exciting light for exciting the solid laser medium from its one end surface for causing excitation thereof and outputs laser light from the other end surface thereof. Also, it is possible to employ a two-directional excitation system for applying exciting light to the front and rear end surfaces of the solid laser medium. In the case of bi-directional excitation, it is possible to employ a structure for placing LDs as excitation light sources on the respective end surfaces and, also, a structure for branching exciting light from a single LD through optical fibers and for causing pumping from the opposite end surfaces of the solid laser medium, and the like.

Particularly, in a laser processing apparatus adapted to excite a solid laser medium, 30 to 40% of the excitation power becomes heat and thus is lost, due to the limit of the quantum efficiency. Therefore, in order to make full use of the extreme performance, there is a need for overcoming various thermal problems, such as thermal birefringence, thermal lenses, thermal doublet lenses and even thermally-induced fractures which become obvious due to strong excitation. Particularly, in the case of an LD-excitation solid laser processing apparatus, the absorption of the exciting light by the solid laser medium induces heat generation, which induces lens effects in the crystal itself, thereby inducing thermal lenses. Such thermal lenses significantly degrade the stability of the laser resonator, thereby largely obstructing the design of the resonator. The use of a bi-directional excitation system can alleviate the above problems. Further, such a bi-directional excitation system can be structured such that a single excitation light source is employed as a laser excitation potion and is branched to be introduced to the respective end surfaces, which can suppress the occurrence of thermal lenses and the like. In addition, it is possible to offer the advantage of improvement of the stability with respect to the excitation wavelength and improvement of the rising characteristic.

### (Laser Light Scanning Portion 9)

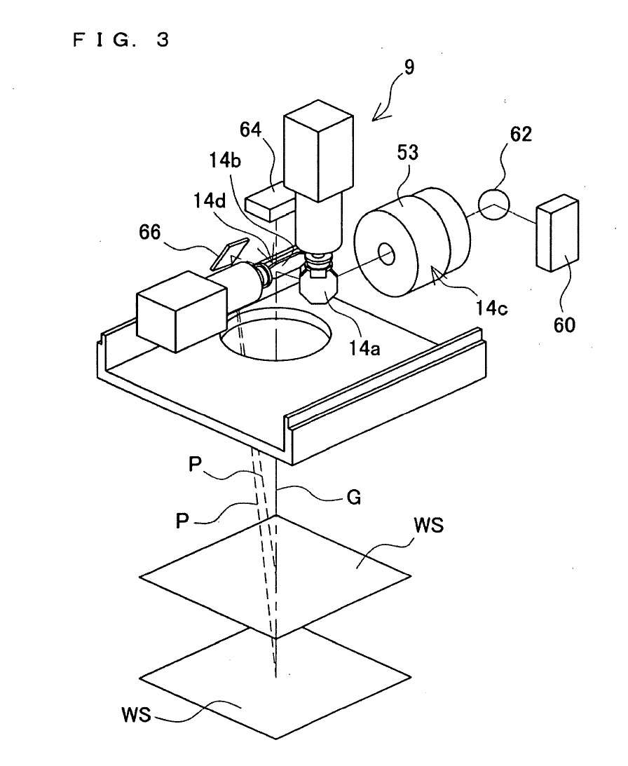

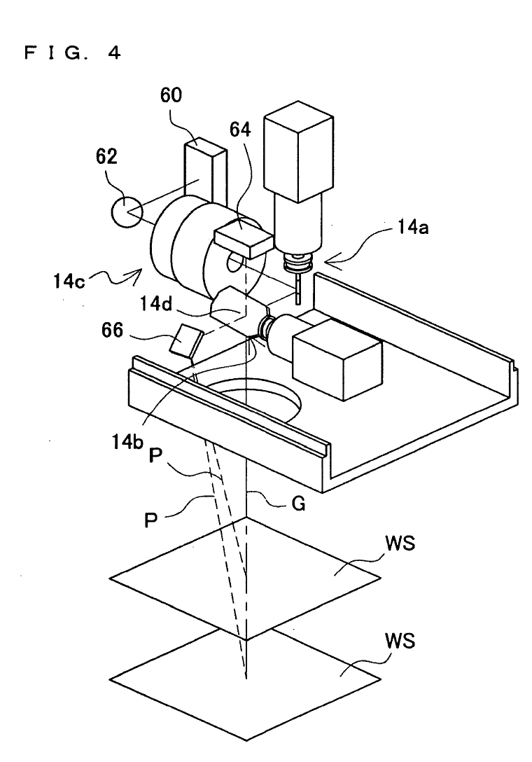

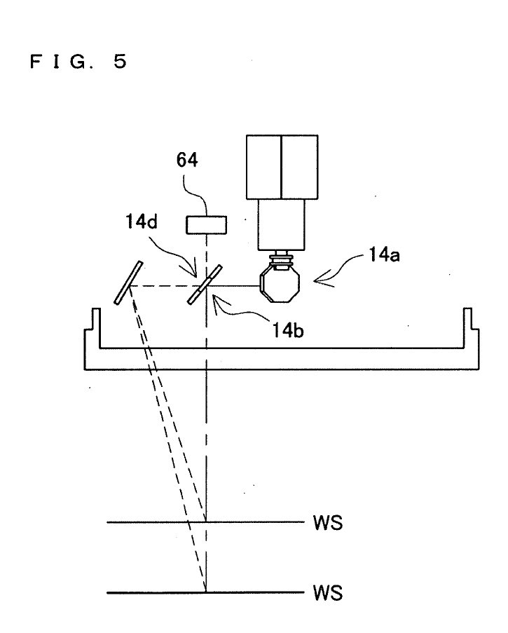

The laser oscillation created by the laser oscillation portion 50 is scanned by the laser-light scanning portion 9. FIGS. 3 to 5 illustrate the laser light scanning portion 9. In these figures, FIG. 3 illustrates a perspective view illustrating the structure of the laser-light scanning portion 9 in the laser processing apparatus, FIG. 4 illustrates a perspective view of the same when viewed in the opposite direction from FIG. 3, and FIG. 5 illustrates a side view of the same. The laser processing apparatus illustrated in these figures includes a beam expander 53 which incorporates a Z-axis scanner having an optical path coincident with that of the laser oscillation portion 50 which generates laser light L, an X-axis scanner 14a, and a Y-axis scanner 14b placed such that it is orthogonal to the X-axis scanner 14a. The laser-light scanning portion 9 is capable of scanning, in a two-dimensional manner, the laser light L emitted from the laser oscillation portion 50 within a work area WS with the X-axis scanner 14a and the Y-axis scanner 14b and, also, is capable of adjusting the working distance, namely the focal distance in the height direction with the Z-axis scanner 14c, thereby enabling printing processing in a three-dimensional manner. Further, it goes without saying that the X-axis scanner, the Y-axis scanner and the Z-axis scanner can be caused to function similarly, even if they are interchanged with one another. For example, the Y-axis scanner can be structured to receive the laser light emitted from the Z-axis scanner or the X-axis scanner can be structured to control the Y axis while the Y-axis scanner can be placed to control the Z axis. Further, in the figures, an fθ lens which is a condenser lens is not illustrated.

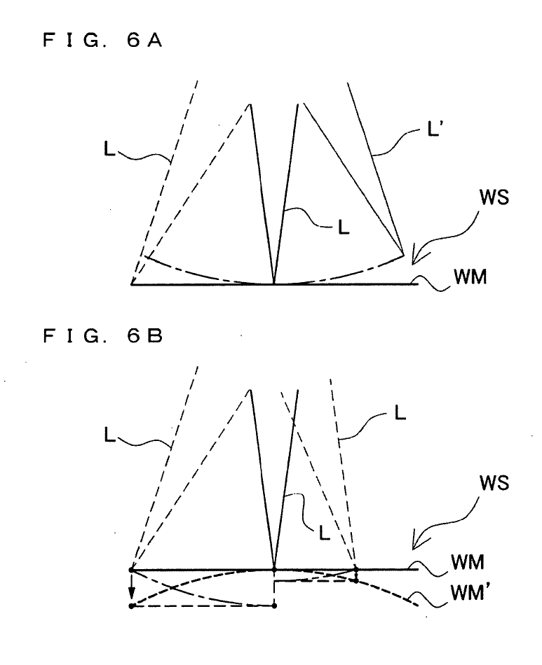

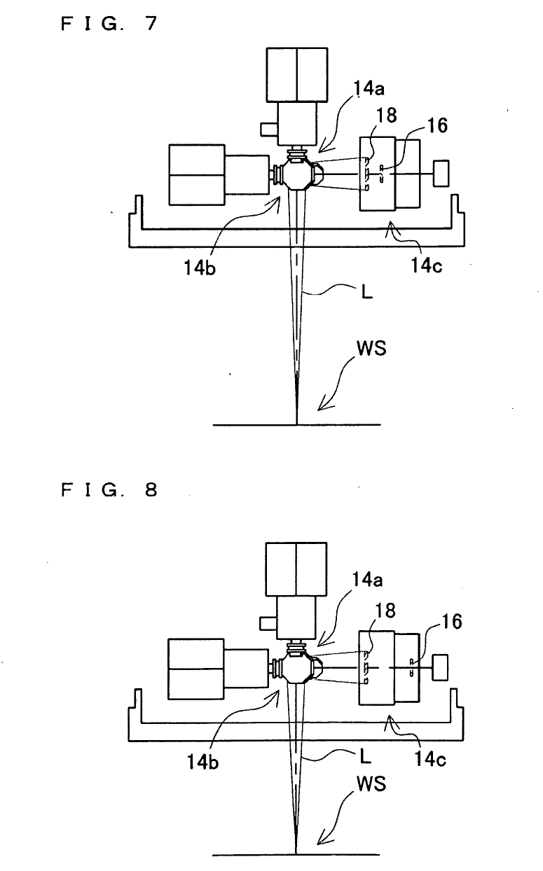

In the laser processing apparatus, generally, in order to condense the laser light reflected by the second mirror (the Y-axis scanner) for directing it to the work area, a condenser lens called an fθ lens is placed between the second mirror and the work area. The fθ lens performs corrections in the direction of the Z axis which are, more specifically, corrections for extending the focus position up to the vicinity of an end portion of the work area WS for positioning it on the to-be-processed surface of the work, as illustrated in FIG. 6A. The focus position of the laser light forms an arc-shaped locus. Accordingly, in cases where the to-be-processed surface is a planer surface, when the focus position is set such that it is coincident with the position in the vertically downward direction, namely with the center of the planer surface WM indicating the to-be-processed surface in FIG. 6A, the focus position is farther from the to-be-processed surface with increasing distance from the center, namely with decreasing distance to the periphery of the work area WS (laser light L′), which causes defocusing, thereby degrading the processing accuracy. Accordingly, the focus position is corrected by the fθ lens, such that the focus position of the laser light L becomes greater with decreasing distance to the end portions of the work area WS, as illustrated in FIG. 6B. By virtually converting the planer surface WM of the to-be-processed surface into a corrected surface with a convex-shaped curved surface illustrated as WM′, it is possible to position the focus position of the laser light L on the planer surface WM.

In the case where it is desired to form a beam with a spot diameter less than about 50 μm, for example, in the laser marker, it is preferable to place the fθ lens. On the other hand, in cases of employing a beam diameter with a spot diameter of about 100 μm (a spot diameter which is frequently employed, in general) which is larger than the above-described small spot diameter, the Z-axis condenser lens provided in the beam expander in the Z-axis scanner can be moved in the direction of the Z axis, which enables performing, through correction control, corrections in the direction of the Z axis which are to be performed through the fθ lens. This enables eliminating the fθ lens in cases where the spot diameter is larger. In the above-described example of FIG. 6A, corrections in the direction of the Z axis which are to be performed by the fθ lens are performed through control of corrections of the Z-axis scanner. On the other hand, in cases where the spot diameter is smaller, the adjustment of the focus position is insufficiently attained with corrections by the Z-axis scanner and, therefore, the fθ lens is employed as described above. In the present embodiment, there are prepared three types of spot diameters of the laser light, which are a small spot, a standard spot and a wide spot. For only the small spot type, among them, the fθ lens is used for correcting the distortions of the end portions of the work area WS. However, for the standard spot and the wide spot, corrections are performed through the Z-axis scanner without using the fθ lens.

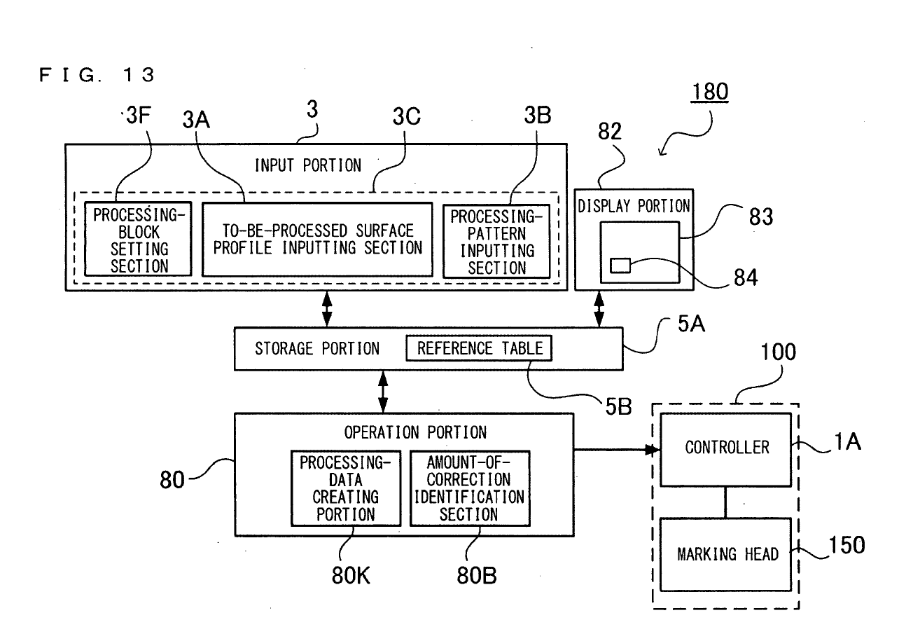

In the case where control of corrections in the direction of the Z axis is performed through the Z-axis condenser lens provided in the beam expander in the Z-axis scanner, the same corrections as the above-described corrections through the fθ lens are performed. The height of the corrected surface WM′ described with reference to FIG. 6B, namely the Z coordinate, is uniquely determined by the X and Y coordinates. Accordingly, by associating a corrected Z coordinate with each X and Y coordinates and by moving the Z-axis scanner to the associated Z coordinate along with the movements of the X and Y axis scanners, it is possible to perform processing at the focus position, anytime. Data of the association is stored in a storage portion 5A illustrated in FIG. 11 and the like, which will be described later. Also, the data of the association can be stored in and transferred to a memory portion 5 provided in the laser control portion in the laser processing apparatus. Accordingly, the corrected Z coordinate is determined according to the movements of the X and Y coordinates within the work area, which enables substantially-uniform irradiation of laser light with an adjusted focus position, within the work area.

Each scanner includes a Galvano mirror which is a total reflection mirror as a reflection surface for reflecting light, a Galvano motor for rotating the Galvano mirror secured to a rotational shaft, and a position detection portion for detecting the rotational position of the rotational shaft and outputting it as a positional signal. Further, the scanners are connected to a scanner driving portion for driving the scanners. The scanner driving portion is connected to a scanner control portion 74 and is adapted to receive control signals for controlling the scanners from the scanner control portion 74 and to drive the scanners based on the control signals. For example, the scanner driving portion adjusts the driving current for driving the scanners based on control signals. Further, the scanner driving portion includes an adjustment mechanism for adjusting the temporal changes of the rotational angles of the respective scanners with respect to control signals. The adjustment mechanism is constituted by semiconductor components such as variable resistances for adjusting respective parameters in the scanner driving portion.

(Z-Axis Scanner 14c)

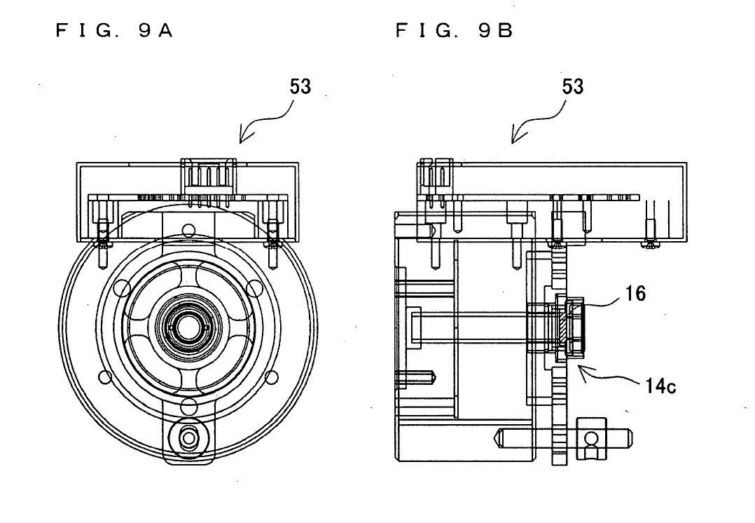

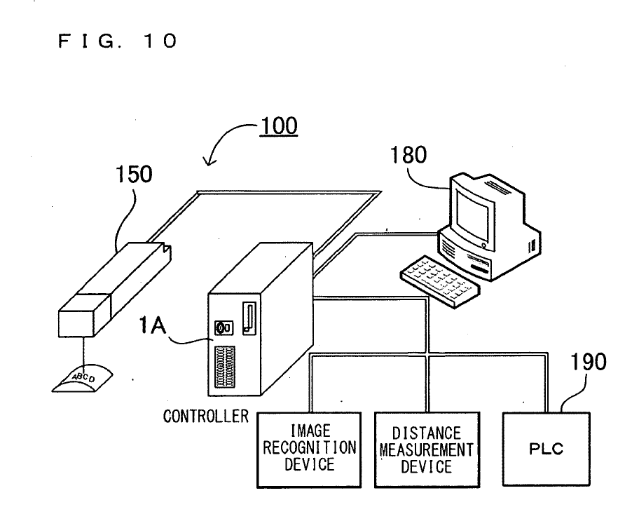

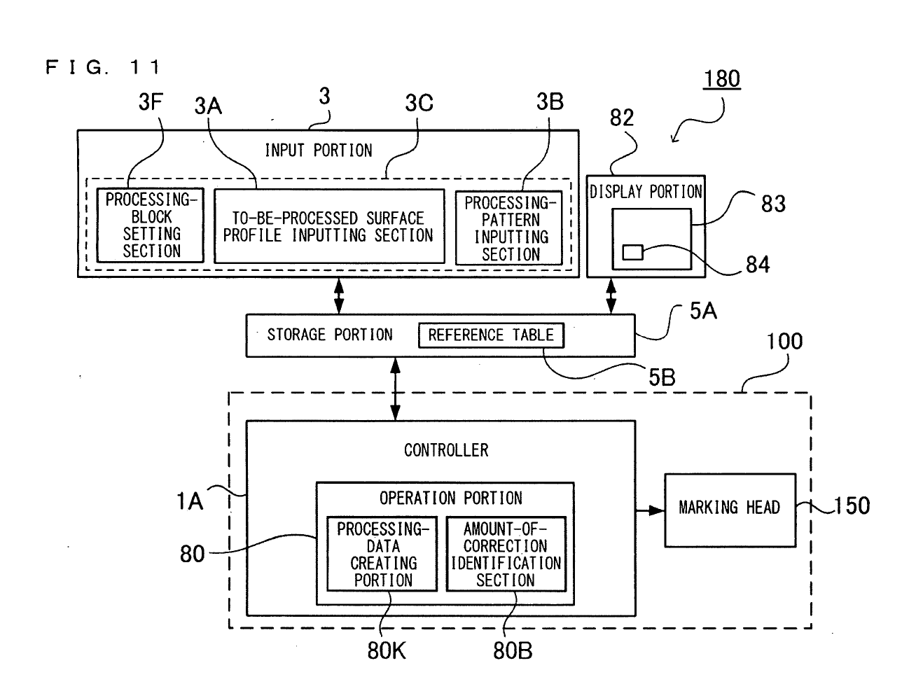

The Z-axis scanner 14c constitutes the beam expander 53 for adjusting the spot diameter of the laser light L for adjusting the focal distance. That is, by changing the distance between the incidence lens and the emission lens through the beam expander, it is possible to increase or decrease the beam diameter of the laser light, thereby changing the focus position. In order to effectively condense the light into the small spot, as illustrated in FIG. 3, the beam expander 53 is placed in the stage previous to the Galvano mirror and, thus, is capable of adjusting the beam diameter of the laser light L outputted from the laser oscillation portion 50 and also adjusting the focus position of the laser light L. There will be described a method with which the Z-axis scanner 14c adjusts the working distance, with reference to FIGS. 7 to 9. FIG. 7 and FIG. 8 are side views of the laser-light scanning portion 9, wherein FIG. 7 illustrates a case where the focal distance of the laser light L is increased, and FIG. 8 illustrates a case where the focal distance is decreased. Further, FIGS. 9A and 9B illustrates a front view and a cross-sectional view of the Z-axis scanner 14c. As illustrated in these figures, the Z-axis scanner 14c includes an incidence lens 16 facing to the laser oscillation portion 50 and an emission lens 18 facing to the laser emission side, wherein the distance between these lenses is made variable. In the example of FIGS. 7 to 9, the emission lens 18 is fixed, while the incidence lens 16 is made slidable through a driving motor or the like, along the direction of the optical axis. In FIGS. 9A and 9B, there are illustrated a mechanism for driving the incidence lens 16, while the emission lens 18 is not illustrated. In the example, a movable member is made slidable in the axial direction through a coil and a magnet, and the incidence lens 16 is secured to the movable member. However, the incidence lens can be fixed while the emission lens is made movable or both the incidence lens and the emission lens can be made movable.

As illustrated in FIG. 7, if the distance between the incidence lens 16 and the emission lens 18 is decreased, the focus position becomes more distant, and the focal distant (the working distance) is increased. On the contrary, as illustrated in FIG. 8, if the distance between the incidence lens 16 and the emission lens 18 is increased, the focus position becomes closer, and the focal distance is decreased.

Further, the laser processing apparatus capable of three-dimensional processing, namely processing on a work in the height direction, can employ other systems, such as a system for physically moving a condenser lens or a system for moving the laser output portion or the marking head itself, as well as the system for adjusting the Z-axis scanner as in FIGS. 7 and 8.

In the example, the Z-axis scanner functions as a focus-position adjustment section capable of adjusting the focus position of the laser light emitted from the Q switch 19 in the direction of the optical axis, while the X-axis scanner and the Y-axis scanner function as a laser-light two-dimensional scanning system for scanning, in a two-dimensional manner, the laser light emitted from the Z-axis scanner.

### (Distance Pointer)

Further, in order to adjust the focus position to the center of the work area of the laser marker which is capable of three-dimensional processing, it is possible to display a guide pattern indicative of the irradiation position in scanning the laser light within the work area WS. The laser-light scanning portion 9 in the laser marker illustrated in FIGS. 3 and 4 includes, as a distance pointer, a guiding light source 60 and a half mirror 62 as an aspect of a guiding-light optical system for making guiding light G from the guiding light source 60 coincident with the optical axis of the laser-light scanning portion 9. Further, the laser-light scanning portion 9 includes, as a pointer-light adjustment system, a pointer light source 64 for irradiation of pointer light P, a pointer scanner mirror 14d as a third mirror which is formed on the back surface of the Y-axis scanner 14b, and a fixed mirror 66 for reflecting the pointer light P from the pointer light source 64 which has been reflected by the pointer scanner mirror 14d for directing it to the focus position. The distance pointer is structured to emit the pointer light P indicative of the focus position of the laser light from the pointer light source 64 and to adjust the pointer light P such that it is directed to a substantially-center position of the guide pattern indicated by the guide light G, thereby indicating the focus position of the laser light.

Further, in the above-described example, the laser-light scanning portion 9 is provided with a mechanism capable of adjusting the focal distance of the laser light, which enables three-dimensional processing. However, the position of the stage on which the work is placed can be made adjustable in the upward and downward directions, which enables performing three-dimensional processing, similarly, by performing control for adjusting the stage height such that the focal point of the laser light is coincident with the to-be-worked surface of the work. Also, the stage can be made movable in the direction of the X axis or the Y axis, which enables eliminating the corresponding scanner in the laser-light scanning portion. These structures can be suitably used in embodiments where processing is performed on a work placed on a stage, not embodiments where a work is transferred through a line.

### (Structure of System of Laser Marker)

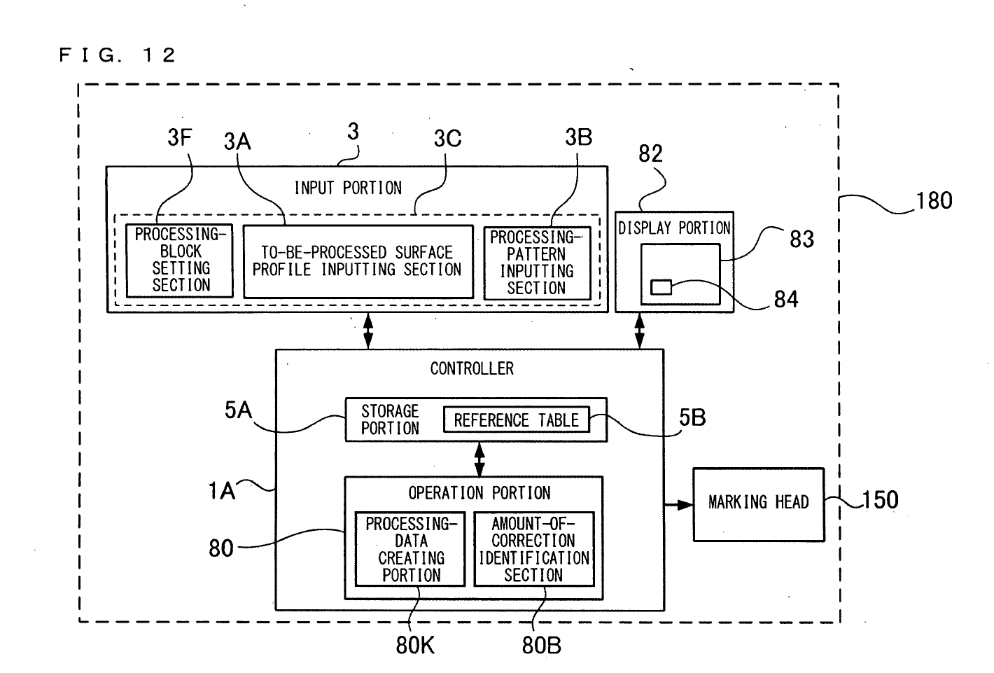

Next, FIG. 10 illustrates the structure of the system of the laser marker capable of three-dimensional printing. The laser processing system illustrated in the figure includes a marking head 150, a controller 1A which is a laser control portion 1 connected to the marking head 150 for controlling it, and a laser-processing-data setting device 180 which is connected to the controller 1A such that it is capable of data communication therewith and sets printing patterns as three-dimensional laser processing data for the controller 1A. The marking head 150 and the controller 1A constitute the laser processing apparatus 100. The laser-processing-data setting function of the laser-processing-data setting device 180 is realized by installing a laser-processing-data setting program in a computer, in the example of FIG. 10. As the laser-processing-data setting device, it is possible to employ a programmable logic controller (PLC) connected to a touch panel, other dedicated hardware or the like, as well as a computer. Further, the laser-processing-data setting device can be caused to function as a control device for controlling the operation of the laser processing apparatus. For example, the function of the laser-processing-data setting device and the function of the controller for the marking head including the laser output portion can be integrated in a single computer. Further, the laser-processing-data setting device can be formed from components separated from the laser processing apparatus or can be integrated with the laser processing apparatus. For example, the laser-processing-data setting device can be formed as a laser-processing-data setting circuit or the like which is incorporated in the laser processing apparatus.

Further, various types of external devices 190 can be connected to the controller 1A, as required. For example, it is possible to install an image recognition device such as an image sensor for determining the type, the position and the like of the work being transferred through the line, a distance measurement device such as a displacement meter for acquiring information about the distance between the work and the marking head 150, a PLC for controlling the devices according to predetermined sequences, a PD sensor for detecting the passage of the work, other various types of sensors and the like, such that the controller 1A is connected to these devices such that it is capable of data communication therewith.

### (Laser-Processing-Data Setting Device)

The laser-processing-data setting device 180 sets laser processing data which is setting information for use in printing planer-surface-shaped printing data in a three dimensional manner. FIG. 11 illustrates a block diagram of an example of the laser-processing-data setting device 180. The laser-processing-data setting device 180 illustrated in the figure includes an input portion 3 for inputting various types of settings, a display portion 82 for displaying the contents of settings and calculated laser processing data, and a storage portion 5A for storing various types of setting data. Further, the storage portion 5A includes a reference table 5B which holds combinations of a plurality of processing parameters in association with one another. Further, the reference table 5B also functions as an amount-of-correction storage section which has preliminarily stored amounts of focus-position correction in the direction of the optical axis due to thermal lens effects, in association with laser-light outputting conditions. The display portion 82 includes a processing-image display portion 83 capable of displaying an image of a to-be-processed surface in a three dimensional manner, and a head-image displaying section 84 capable of displaying an image of the marking head, when the processing-image displaying portion 83 is caused to display an image of the to-be-processed surface in a three dimensional manner. The input portion 3 realizes the functions of a to-be-processed-surface profile inputting section 3A for inputting profile information indicative of a three-dimensional shape of the surface of the work to be subjected to printing, a processing-pattern inputting section 3B for inputting printing-pattern information, a processing-block setting section 3F capable of setting a plurality of processing blocks within the work area and setting a processing pattern for each processing block, a group setting section for setting processing groups each constituted by a combination of the plurality of processing blocks set by the block setting section 3F, and a processing-pattern position adjustment section capable of adjusting the positions of the processing patterns to be placed on the to-be-processed surface, as a processing-condition setting portion 3C for setting laser-light outputting conditions and processing pattern as processing conditions for processing in desired processing patterns. The to-be-processed-surface profile inputting section 3A further realizes the functions of a basic-graphic specification section for specifying a basic graphic indicative of the to-be-processed surface, and a three-dimensional-shape data inputting section for inputting, from the outside, three-dimensional-shape data indicative of the to-be-processed surface. The storage portion 5A corresponds to the memory portion 5 in FIG. 1 and stores information such as the profile information, the printing-pattern information and the like which have been set by the input portion 3. The storage portion 5A as described above can be constituted by a storage medium such as a fixed storage device, a semiconductor memory, or the like. The display portion 82 can be constituted by a dedicated display or the monitor of a computer connected to the system.

### (Operation Portion 80)

On the other hand, the controller 1A in the laser processing apparatus 100 includes an operation portion 80 constituting a processing-data creating portion 80K for creating laser processing data based on information inputted from the input portion 3, and the like. The operation portion 80 realizes the functions of the processing-data creating portion 80K for creating processing data for use in actual processing based on the processing condition set by the processing-condition setting portion 3C, an amount-of-correction identification section 80B for identifying, as an amount of focus-position correction, the deviation of the focus position in the direction of the optical axis which is caused by thermal lens effects induced based on the laser-light outputting condition set by the processing-condition setting portion 30, an initial-position setting section for determining an initial position at which the laser processing data is to be placed on the to-be-processed surface in displaying the three-dimensional laser processing data on the display portion 82, a processing-failure area detection section for detecting, out of the work area, processing-failure areas which can not be irradiated with laser light and thus can not be processed or can not be successfully processed, a high-light processing section for performing high-light processing for displaying the processing-failure areas detected by the processing-failure-area detection section in a different manner from that for areas which can be processed, and a setting alarm section for detecting the fact that a setting has been made in such a way that some processing is to be performed on the area including the processing-failure areas and for generating an alarm, when processing patterns are set by the processing-condition setting portion 3C. Further, as required, the operation portion 80 can be caused to realize the functions of a processing-condition adjustment section for adjusting the processing conditions for the processing-failure areas such that the processing thereon is enabled, a coordinate conversion section for converting printing-pattern information having a planer-surface shape into three-dimensional spatial coordinate data such that the printing pattern is virtually coincident with the surface to be subjected to printing, and the like. The operation portion 80 is constituted by an FPGA, an LSI and the like.

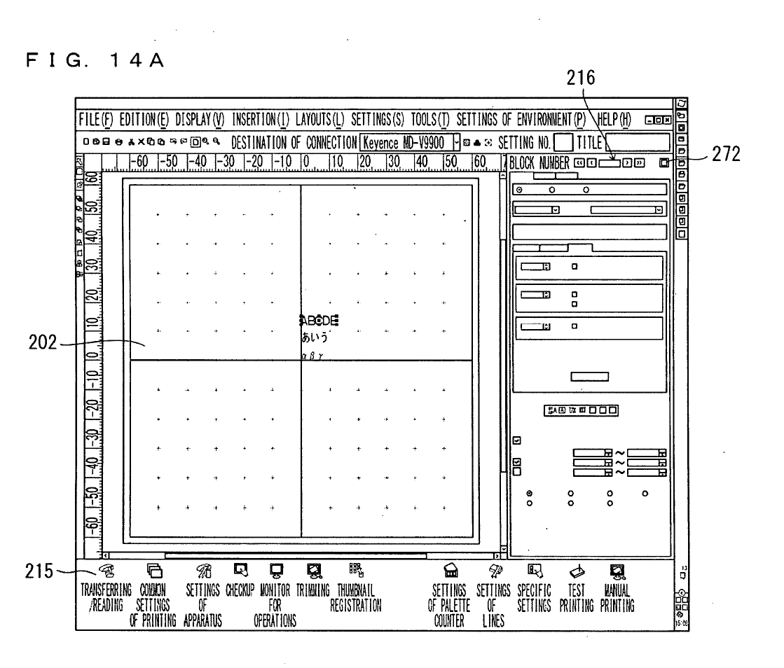

Further, in the example of FIG. 11, the laser-processing-data setting device 180 is constituted by dedicated hardware, but these components can be realized by software. Particularly, as illustrated in FIG. 10, a laser-processing-data setting program can be installed in a general-purpose computer, and the computer can be caused to function as the laser-processing-data setting device 180. Further, in the example of FIG. 11, the laser-processing-data setting device 180 and the laser processing apparatus 100 can be formed as separate devices, but they can be integrated with each other, as illustrated in FIG. 12.

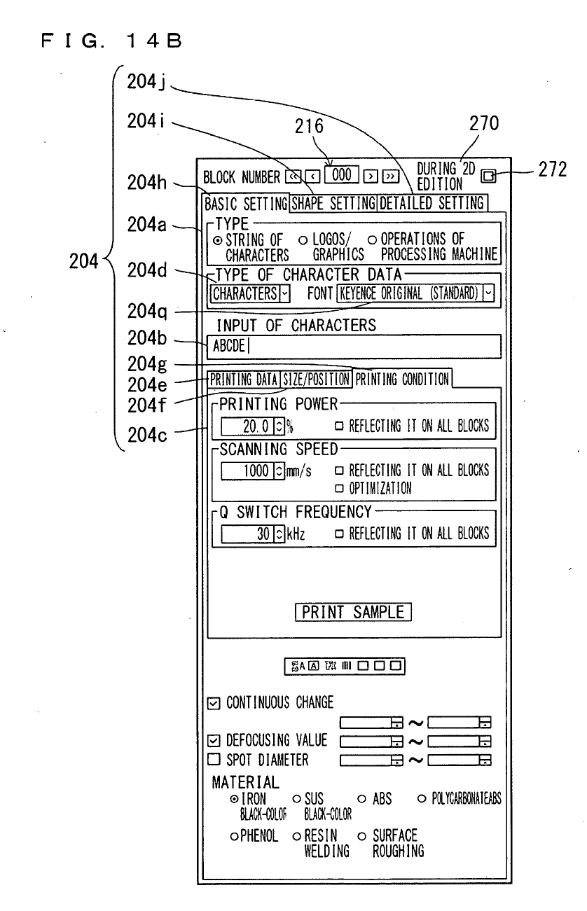

The processing-data creating portion 80K is placed in the controller 1A in the laser processing apparatus 100. Further, as illustrated in FIG. 13, the processing-data creating portion 80K can be provided in the laser-processing-data setting device 180. For example, a laser-processing-data program is installed in a general purpose computer, and the computer is caused to function as the laser-processing-data setting device 180 for realizing the function of the processing-data creating portion 80K. Also, the processing-data creating portion can be provided in both of the laser processing apparatus 100 and the laser-processing-data setting device 180, which enables both the laser processing apparatus 100 and the laser-processing-data setting device 180 to create laser processing data and also enables them to receive, transmit, edit and display laser processing data.

### (Laser-Processing-Data Setting Program)

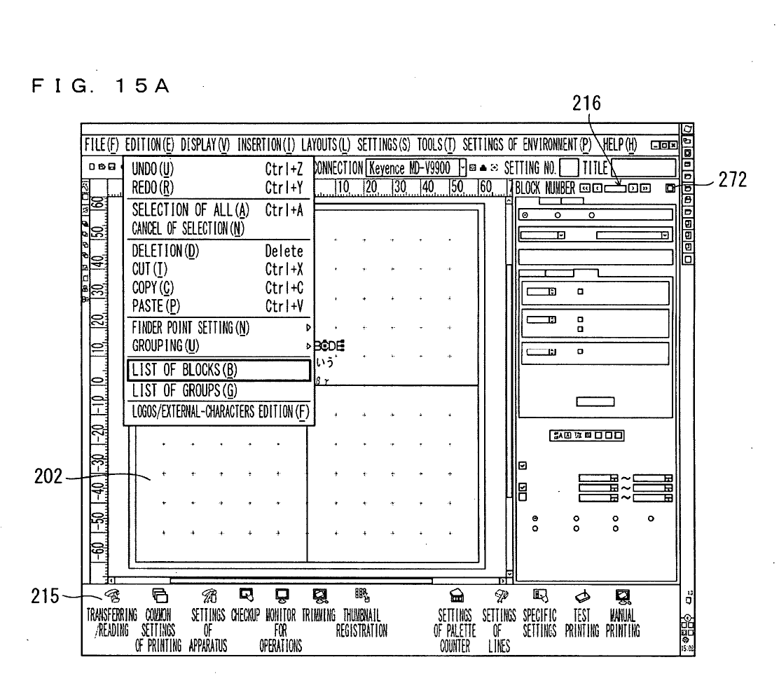

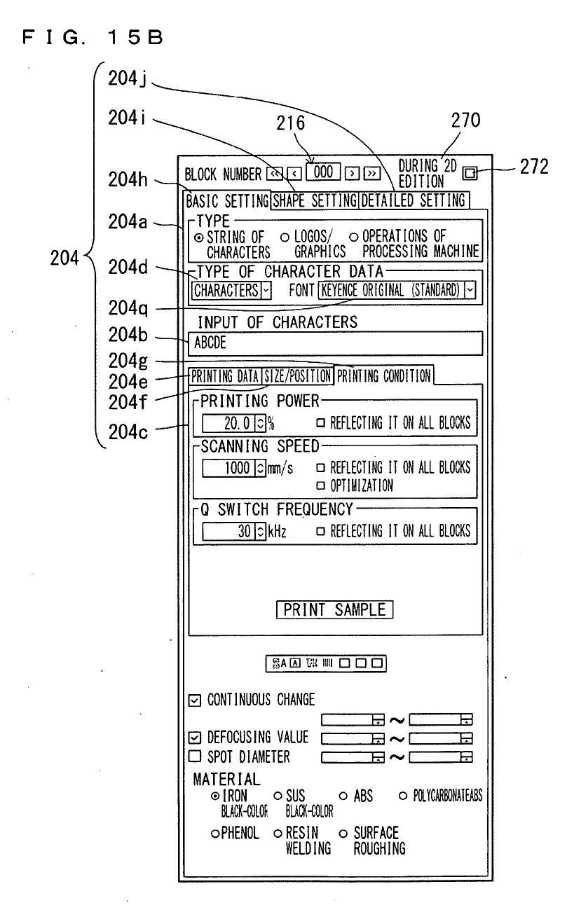

Next, with reference to user interface screen pages in FIGS. 14 to 16, there will be described procedures for creating processing patterns, based on character information inputted from the processing-condition setting portion 3C, using the laser-processing-data setting program. Further, it goes without saying that the placements, shapes, way of display, sizes, colors, designs and the like of respective input fields, respective buttons and the like can be properly changed, as required, in the examples of the user interface screen pages of the program. By changing the design, it is possible to realize an easily-viewable display which facilitates evaluations and determinations or a layout which facilitate operations. For example, it is possible to properly make changes, for example, in such a way as to display a screen page for detailed settings in a separated window or in such a way as to display a plurality of screen pages in a single display screen page. Further, ON/OFF operations and specification of numerical values, command inputs and the like on the buttons and the input fields which are virtually provided on the user interface screen pages of the program are performed through the input portion 3 which is connected to the computer which incorporates the program. In the present specification, the term “pushing” includes physically touching buttons for operating them and, also, includes clicking or selecting buttons through the input portion for virtually pushing them. The input/output device constituting the input portion and the like is connected to the computer in a wired manner or a wireless manner or is secured to the computer and the like. Common examples of the input portion include various types of pointing devices, such as a mouse, a keyboard, a slide pad, a track point, a tablet, a joystick, a console, a jog dial, a digitizer, a light pen, ten keys, a touch pad, an Acu-Point and the like. Further, these input/output devices can be also used for operating hardware such as the laser processing apparatus and the like, as well as for operations of programs. Further, it is also possible to employ a touch screen or a touch panel as the display itself of the display portion 82 for displaying the interface screen pages, which enables users to directly touch the screen pages with their hands for performing inputting and operations. Also, it is possible to employ sound inputting section or other existing inputting section or both of them.

The laser-processing-data setting program enables edition of three-dimensional laser processing data. However, in consideration of users which are not good at edition of three-dimensional data, it is also possible to prepare a “2D edition mode” which allows only making settings in a planer-surface manner and does not allow edition in a three-dimensional manner, in such a way as to enable switching between the “2D edition mode” and a “3D edition mode” which allows processing of three-dimensional laser processing data. In the case of providing such a plurality of edition modes, there are provided an edition-mode display field 270 for indicating the current edition mode, and an edition-mode switching button 272 for switching among the edition modes. In the example of FIGS. 14A and 14B, when the laser-processing-data setting program is activated, the laser-processing-data setting program is placed in the “2D edition mode”, and the edition-mode display field 270 provided at a right upper position in the screen page is caused to display the fact that the current edition mode is “during 2D edition”. By setting the two-dimensional edition mode which enables performing operations relatively easily as a default edition mode at the time of activation, it is possible to enable users which are not good at edition of three-dimensional laser processing data to perform operations without hesitation. Also, the edition mode at the time of activation can be made changeable by users. This enables users who are skilled in operations to make settings in such a way as to enable edition of three-dimensional laser processing data without switching over the edition mode.

Further, on the edition-mode switching button 272 provided at the right of the edition-mode display field 270, there are displayed characters “3D” indicative of the fact that the current edition mode can be switched over to the 3D edition mode. At this state, if the edition-mode switching button 272 is pushed, the current edition mode is switched over to the “3D Edition Mode” and, also, the display in the edition-mode display field 270 is changed to “During 3D Edition”. Further, the edition-mode switching button 272 is caused to display characters “2D” indicative of the fact that the current edition mode can be switched over from the 3D edition mode to the 2D edition mode. By providing the “2D Edition Mode” which restricts or eliminates 3D display and edition as described above, it is possible to provide user interfaces which enable only settings and edition of processing data for a two-dimensional to-be-processed surface, thereby enabling simplification of the user interfaces and, therefore, improvement of the operability, when the user desires to perform settings and edition of processing data for a two-dimensional to-be-processed surface. Further, when the user desires to perform settings and edition of processing data for a three-dimensional to-be-processed planer surface, instead of performing unfamiliar 3D display at first, the user can perform settings and edition of the processing data for a two-dimensional to-be-processed surface in the above-described “2D Edition Mode” which has been familiar to him or her and, thereafter, can process and edit the two-dimensional processing data which has been set and processed in the “2D Edition Mode” into desired three-dimensional processing data in “3D Edition Mode”. Therefore, even in the “3D edition mode”, it is possible to provide easily understandable user interfaces for users, thereby improving the operability.

An example of the processing-condition setting portion 3C will be described, with reference to FIGS. 14A and 14B. FIGS. 14A and 14B illustrate an exemplary user interface screen page of the laser-processing-data setting program, wherein there is provided, in the left side of the screen page, an edition display field 202 for displaying an image of a processing pattern to be printed on a work and, further, there is provided, in the right side, a printing-pattern input field 204 for specifying various types of data as concrete processing conditions. In the printing-pattern input field 204, it is possible to switch among a “Basic Setting” tab 204h, a “Shape Setting” tab 204i and a “Detailed Setting” tab 204j, as tabs for selecting setting items. In the example of FIG. 14B, there is being selected the “Basic Setting” tab 204h, which is provided with a type-of-processing specification field 204a, a character-data specification field 204d, a character input field 204b and a detailed-setting field 204c. The type-of-processing specification field 204a is for specifying, as a type of the processing pattern, a printing pattern including a string of characters, symbols, logos, designs and images such as graphics or for specifying whether or not operations as a processing machine are to be performed. In the example of FIG. 14B, a selection of a string of character logos/graphics or whether operations of a processing machine are to be performed is made through radio buttons, in the type-of-processing specification field 204a. Further, the character-data specification field 204d is for specifying a type of character data. In this case, any one of characters, a barcode, a two-dimensional code and an RSS/composite code (CC) is selected from a pull-down menu. Further, a more detailed type is selected from the type specification field 204q, according to the selected type of character data. For example, when characters have been selected, a type of the font is specified. When a barcode has been selected, a type of the barcode such as CODE39, ITF, 2 of 5, NW7, JAN or Code 28 is specified. When a two-dimensional code has been selected, a type of the two-dimensional code such as a QR code, a micro QR code or DataMatrix is specified. When an RSS/Composite Code has been selected, a type of the RSS code such as RSS-14, RSS-14 CC-A, RSS Stacked, RSS Stacked CC-A, RSS Limited or RSS Limited CC-A is specified or a type of the RSS composite code is specified. The character input field 204b is for inputting information about characters which are desired to be printed. When characters have been selected from the character-data specification field 204d, the inputted characters are printed as such as a string of characters. On the other hand, when symbols have been specified, a processing pattern is created by encoding the inputted string of characters according to the selected type of symbols. The creation of the processing pattern can be performed by the processing-data creation portion, as well as by the processing-condition setting portion 3C. In this example, the creation of processing data is performed by the operation portion 80. Further, the detailed-setting field 204c is for specifying details of the printing condition, in a “Printing Data” tab 204e, a “Size/Position” tab 204f, a “Printing Condition” tab 204g and the like, by switching among the tabs. The “Printing Condition” tab 204g is for setting the printing power, the scanning speed and the like.

Further, if the processing-machine operation is selected from the type-of-processing specification field 204a, this enables selecting a type of processing from a pull-down menu, thereby enabling selecting a fixed point, a straight line, a broken line, a counterclockwise-circle/ellipse, a clockwise-circle/ellipse, a trigger-ON fixed middle point, or the like. For the processing-machine operation, a line-segment coordinate specification field is provided, instead of the character input field, for the processing pattern, for specifying the locus of a straight line, an arc or the like, with coordinates. Also, the laser processing apparatus is further capable of printing image data of logos, graphics and the like, as well as strings of characters.

### (Processing-Block Setting Section 3F)

As described above, printing-pattern information is set for a single printing block. Also, a plurality of printing blocks can be set. That is, the plurality of printing blocks can be set in a processing area, and printing processing can be performed thereon under different printing conditions. The plurality of printing blocks can be set in a single work or a surface to be subjected to processing (printing), or respective printing blocks can be set for a plurality of works existing in a to-be-processed area.

The setting of processing blocks is performed by the processing-block setting section 3F. In the example of FIGS. 14A and 14B₁, as an aspect of the processing-block setting section 3F, a block-number selection field 216 is provided above the printing-pattern input field 204. In the block-number selection field 216, there are provided a number display field for displaying a block number, and a “>” button, a “>>” button, a “<” button and a “<<” button as number specification section. If the “>” button is pushed, the block number is incremented by 1 for enabling making settings for a new printing block. Further, in changing the settings for a printing block for which the settings have been completed, similarly, the “>” button can be operated to select the block number and call up the settings of the corresponding printing block. Further, if the “>>” button is pushed, the current block number is jumped to the last block number. Further, if the “<” button is pushed, the block number goes back by one and, if the “<<” button is pushed, the current block number is jumped to the first block number. Further, a numerical value can be directly inputted to the numerical-value display field in the block-number selection field 216 for specifying the block number. As described above, a printing block is selected through the block-number selection field 216, and printing-pattern information is specified for each printing block. In this example, block numbers in the range of 0 to 255 can be set.

Further, regarding the placement of printing blocks, it is possible to make settings for the layout, such as adjustments of the placement position (centering with respect to a center axis, right alignment, left alignment and the like), the order of superimposition for cases where the plurality of printing blocks are superimposed on one another, position adjustments. Also, it is possible to specify the placement of each printing block with coordinates and the like. For example, it is possible to numerically specify the X coordinate and the Y coordinate of the block coordinates, in the “Size/Position” tab 204f constituting the processing-pattern position adjustment section. Further, on this screen page, it is possible to specify a character height, a character width, a character interval and the like, as character sizes. Further, as a block shape, it is possible to specify horizontal writing or vertical writing, the inner periphery or the outer periphery of a circular cylinder in cases of three-dimensional printing, and the like.

### (List of Settings of Printing Blocks)

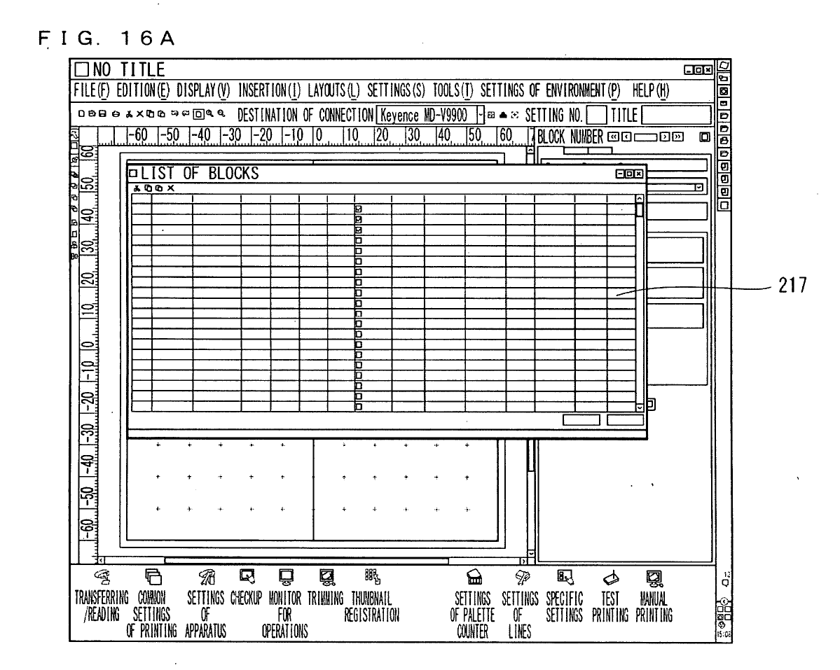

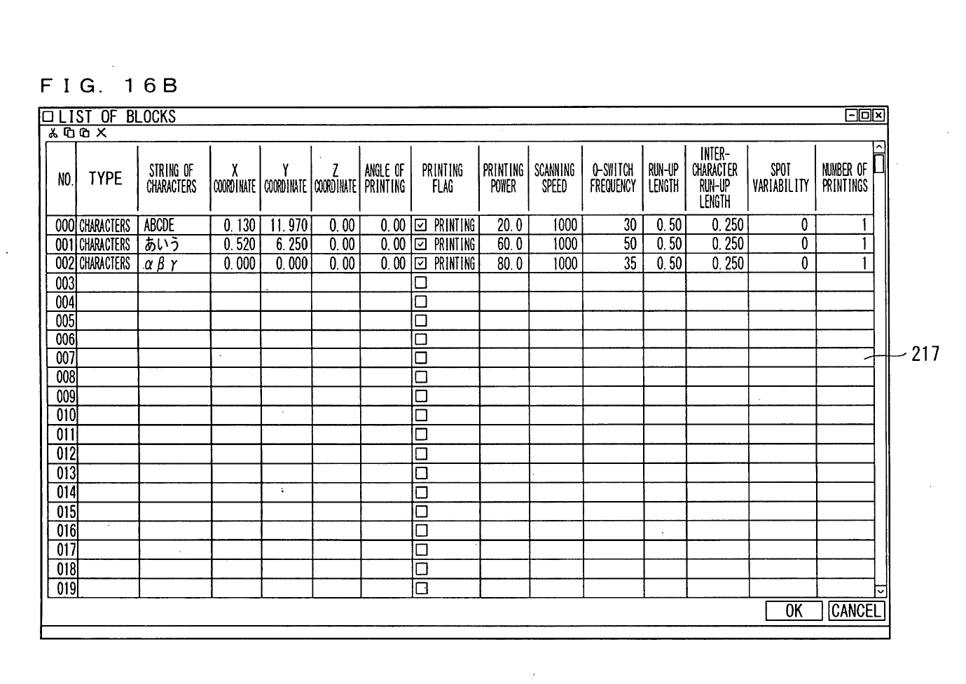

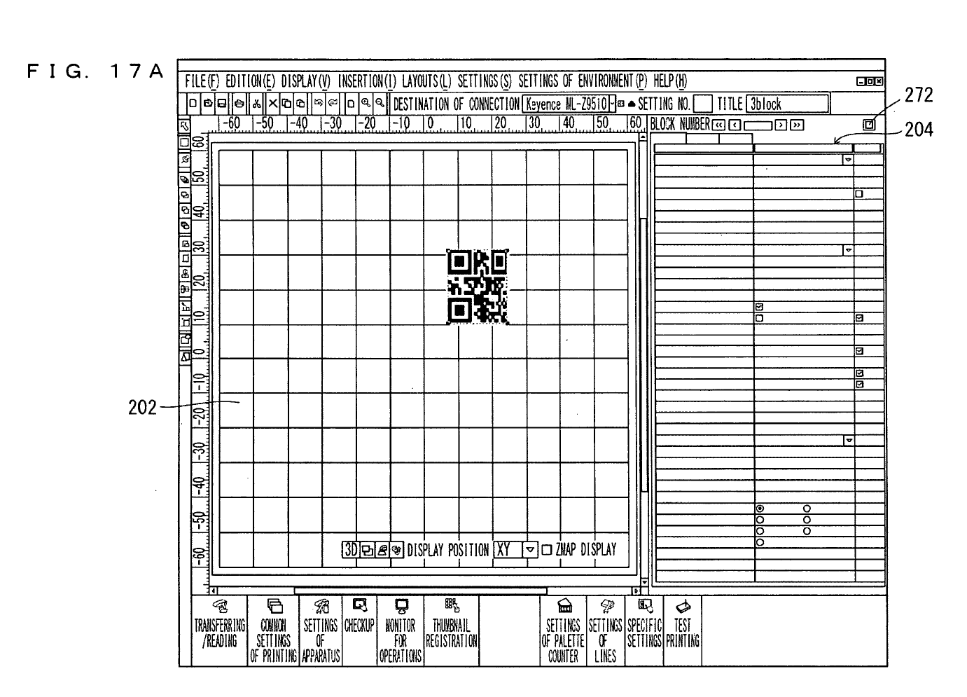

The setting items for printing blocks for which settings have been completed can be displayed in a list. In the example of FIGS. 14A and 14B, as illustrated in FIGS. 15A and 15B, if “List of Blocks” is selected from “Edition” in the menu, a block-list screen image 217 in FIGS. 16A and 16B is displayed on a different window. It is possible to eliminate, from the screen page for the list, printing blocks for which settings have been completed and, also, it is possible to add, thereto, new printing blocks through copying. Also, a desired printing block can be selected, and setting items therefor can be adjusted.

### (Delay Operations)

In general, the laser excitation portion 6, the Q switch 19, the X-axis scanner 14a and the Y-axis scanner 14b are excellent in response speed, while the Z-axis scanner 14c has a low response speed, which induces a delay time from the Z-axis scanner receives a command for operation from the laser driving control portion until the Z-axis scanner completes the commanded operation. Particularly, in cases of setting different processing conditions such as different laser powers and different Q-switch frequencies for respective the plurality of processing blocks, the Z-axis scanner is operated for each of the processing blocks and, in cases where there is a large movement distance between adjacent processing blocks, the delay time is obvious. Accordingly, if operations of the respective components are executed immediately after the reception of a command for operations, irradiation of the laser light is started at a state where the adjustment of the focus position through the Z-axis scanner has not been completed and, thus, at the portion where the processing is started, the processing is performed at a state where the focus portion is deviated, thereby degrading the processing quality. To cope therewith, a delaying operation can be performed for operating the respective components in such a way as to preliminarily take account of the time required for operating the Z-axis scanner, for overcoming the above problem.

More specifically, the delay time of the Z-axis scanner is specific to the Z-axis scanner and, therefore, if the coordinate positions of a start position and an end position of movement, a movement distance therebetween or a processing pattern is determined, the delay time can be calculated. Accordingly, by calculating the delay time of the Z-axis scanner according to the processing pattern through the laser driving control portion or the like and, further, by controlling the laser driving control portion in such a way as to delay the start of outputting of the laser light by the calculated delay time, it is possible to perform processing at a state where the focus position has been accurately adjusted, thereby maintaining the result of processing at high quality.

### (Procedures for Settings of Laser Processing Data)

There will be described procedures with which the processing-data creating portion 80K creates a processing pattern using printing conditions set through the processing-condition setting portion 3C, using the laser-processing-data setting program as described above. At first, a processing pattern is set. In this case, a string of characters is inputted to the processing-condition setting portion 3C and, further, a type of symbols into which the string of characters is to be encoded is specified. In the example of FIG. 14B, a string of characters is selected from the type-of-processing specification field 204a, then a string of characters “ABCDE” is inputted to the character input field 204b, further “Characters” is selected as a type from the field of “Type of Character Data” in the character-data specification field 204d and, further, a type of the font is specified. Based on the information specified as described above, the operation portion 80 creates a processing pattern. In this case, a string of characters is selected and, therefore, an image of a printing pattern for the characters is displayed on the edition display field 202.

Further, while, in the example, the operation portion 80 automatically creates a processing pattern based on the character information inputted from the processing-condition setting portion 3C, symbols can be directly inputted thereto. For example, it is possible to employ a structure for selecting, in the processing-condition setting portion, symbol image data which has been already created and then inputting it thereto or a structure for attaching, in the processing-condition setting portion, symbols which have been created by other programs.

Next, profile information is inputted to the processing-condition setting portion 3C. In the example of FIG. 14B, the tab in the printing-pattern input field 204 is changed over from the “Basic Setting” tab 204h to the “Shape Setting” tab 204i, and a basic graphic is selected from a profile specification field. Thus, the display in the edition display field 202 can be changed over to the specified shape. Further, if the display form of the edition display field 202 is changed over to 3D display, this enables recognizing the three-dimensional shape of the to-be-processed surface in a stereoscopic manner. Further, the specification of a shape can be performed for each string of characters or each printing block, but a shape can be comprehensively specified for a plurality of strings of characters.

After the printing-pattern information is specified and a plan view of the processing pattern is displayed in the edition display field 202 as described above, profile information can be specified and can be converted into a three-dimensional processing pattern, and the three-dimensional processing pattern can be checked in the edition display field 202, which enables visually checking the change of the processing pattern. Further, the above-described procedures can be interchanged in terms of the order. In other words, the shape of the to-be-processed surface can be specified at first and, thereafter, printing-pattern information can be specified.

After the three-dimensional spatial coordinate data is obtained as processing data as described above, adjustment operations are performed, as required. For example, layout adjustments and fine adjustments in the height direction (the z direction) can be performed. For fine adjustments, it is possible to employ techniques such as adjustments through a slider provided on the user interfaces of the program or wheel rotations through a mouse.

After the laser processing data is finally created and setting operations are completed according to the above-described procedures, the obtained laser processing data is transferred from the laser-processing-data setting program to the controller 1A in the laser processing apparatus illustrated in FIG. 10. In order to attain the transferring, a “Transferring/Reading” button 215 provided at a lower left portion on the screen page of the laser-processing-data setting program is pushed. Thus, the setting data is transferred from the storage portion 5A to the memory portion 5 in the controller 1A and then is decompressed and is changed in contents of settings therein, thereby reflecting the new printing conditions therein. References are made to the laser processing data decompressed in the memory portion 5 and other processing conditions therein, during processing operations.

The laser processing apparatus performs printing processing, based on laser processing data. Also, it is possible to perform test printing, in advance of the start of actual processing. This enables preliminarily checking whether printing can be performed in a desired printing pattern. Further, resetting of laser processing data can be performed, based on the result of test printing.

While, in the above-described example, there has been described a case where a single printing pattern is specified for a single work, the plurality of printing patterns can be specified for a single work by repeating the same procedures. Further, the present invention is not limited to the structure for displaying only a single work on a single screen page of the laser-processing-data setting program, and the plurality of works can be displayed on a single screen page, and printing patterns can be specified for the respective works.

### (Setting of Amount of Defocusing)

The above-described processing-data creating portion 80K creates processing data, in such a way as to realize basic setting conditions which conform to the three-dimensional to-be-processed surface, based on the processing conditions set by the processing-condition setting portion 3C. Further, the amount of defocusing can be also purposely set such that the basic setting conditions do not conform to the to-be-processed surface.

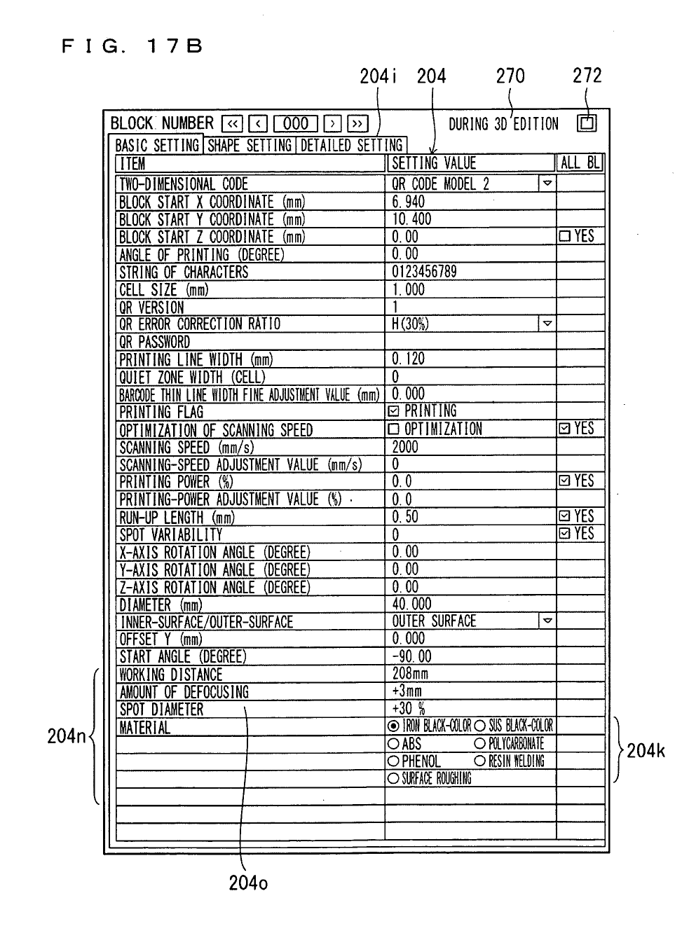

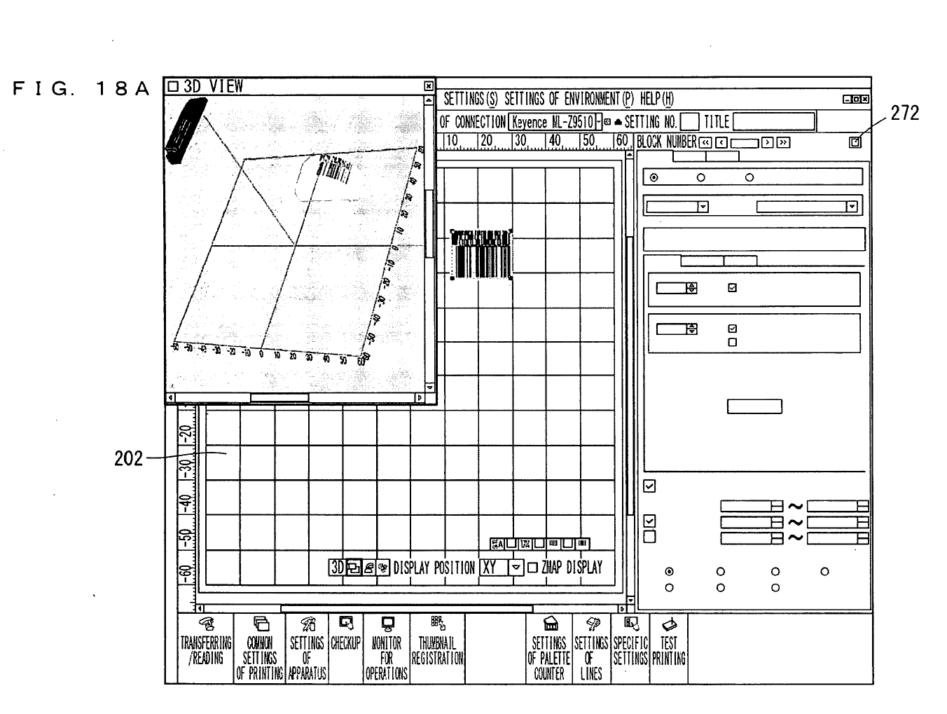

In order to purposely set a certain amount of defocusing for a surface to be subjected to printing, an amount of defocusing is specified in basic setting conditions for making the focus coincident with the surface to be subjected to printing. FIGS. 17A and 17B illustrate an example of a processing-parameter setting screen page for making settings as described above. In FIGS. 17A and 17B, a defocusing setting field 204o for setting a defocusing value is provided in the processing-parameter setting field 204n, which enables the user to input a desired value. By inputting a positive value, for example, as a defocusing value, it is possible to set the focus position at a position which is farther from the laser processing apparatus than the surface to be subjected to printing, by an amount corresponding to the set value. On the contrary, by inputting a negative value, it is possible to set the focus position at a position which is closer to the laser processing apparatus than the surface to be subjected to printing by an amount corresponding to the set value.

Further, as setting items for setting processing conditions, it is possible to set processing parameters such as a spot diameter as an amount of defocusing of the laser light and a work material. In this case, by automatically changing the other processing conditions along with the change of a specified single processing parameter, the user is enabled to easily determine the conditions which include only the specified setting item which has been changed. In the screen page of the laser-processing-data setting program illustrated in FIGS. 17A and 17B, there are provided fields for setting a working distance, an amount of defocusing, a spot diameter and a to-be-processed work, in lower stages in the “Detailed Setting” tab 204j in the right side of the screen page. The working distance is automatically set in general, since it is determined depending on the laser processing apparatus. The amount of defocusing specifies the amount of offset from the focus position of the laser light (the working distance). Further, the spot diameter is specified as the ratio thereof with respect to the spot diameter at the focus position. Further, regarding the to-be-processed work, by selecting a material of the to-be-processed work and an aim of the processing from selection options 204k, it is possible to adjust the power density of the laser light to a power density suitable for processing on the selected work. In this example, there are listed work materials such as black-color printing on Fe, black-color printing on stainless steel, ABS resin, polycarbonate resin, phenolic resin, and aims of processing such as resin welding, surface roughing. The user can select any of radio buttons, according to a desired aim of processing.

These setting items are correlated to one another. That is, by adjusting the amount of defocusing, the power density of the laser light can be adjusted, and the spot diameter is also changed at the same time. Further, if a work material and an aim of processing are selected, a power density of the laser light suitable for the aim is selected and, therefore, the amount of defocusing and the spot diameter are changed. Accordingly, conventionally, when it is desired to adjust the power density of the laser light while maintaining the spot diameter at a constant value, there has been a need for, in addition to setting an amount of defocusing, adjusting the other setting items such as the output value of the laser light and the scanning speed, in order to search a combination of processing parameters which prevents the spot diameter from being changed. This operation involves repeating trial and error in adjusting the values of respective items while checking the result of actual scanning of laser light for processing the work for finding out an optimum combination of processing parameters, thereby involving extremely complicated operations.

Therefore, it is possible to preliminarily register, in a reference table 5B, combinations of a single processing parameter and values of other processing parameters to be changed according to the single processing parameter. When a single processing parameter is adjusted, a reference is made to the reference table 5B, a corresponding combination of the other processing parameters is extracted therefrom, and these values are automatically set. This enables changing only a required setting item. More specifically, if any one of an amount of defocusing, a spot diameter and a to-be-processed work is set through the screen page of FIGS. 17A and 17B, corresponding values are automatically inputted to the other setting items. Further, even if the amount of defocusing is changed at this state, the other processing parameters (for example, the laser output and the scanning speed) and the like are automatically adjusted, such that the spot diameter and the to-be-processed work are maintained at constant values. This enables the user to rapidly change only a desired item, thereby attaining adjustments to a desired result of processing extremely easily.

### (Continuous Change of Amount of Defocusing)

Further, processing parameters can be continuously changed during laser processing. This enables forming inclined surfaces through cutting processing on the work surface or performing logo printing processing in a brush writing manner on the work surface. Such processing can be realized by making settings in such a way as to continuously change the amount of defocusing and the spot diameter of the laser light. In this case, the processing-data creating portion 80K continuously adjusts other processing parameters such that they follow the continuous changes of the amount of defocusing and the spot diameter as described above, thereby realizing automatic adjustments such that only the specified setting item is continuously changed. As a result, processing is performed in such a way as to maintain, at the previous values, the setting items which are not required to be changed, such as the processing position and the size. This enables easily setting the processing conditions in such a way as to change only the setting items desired by the user.

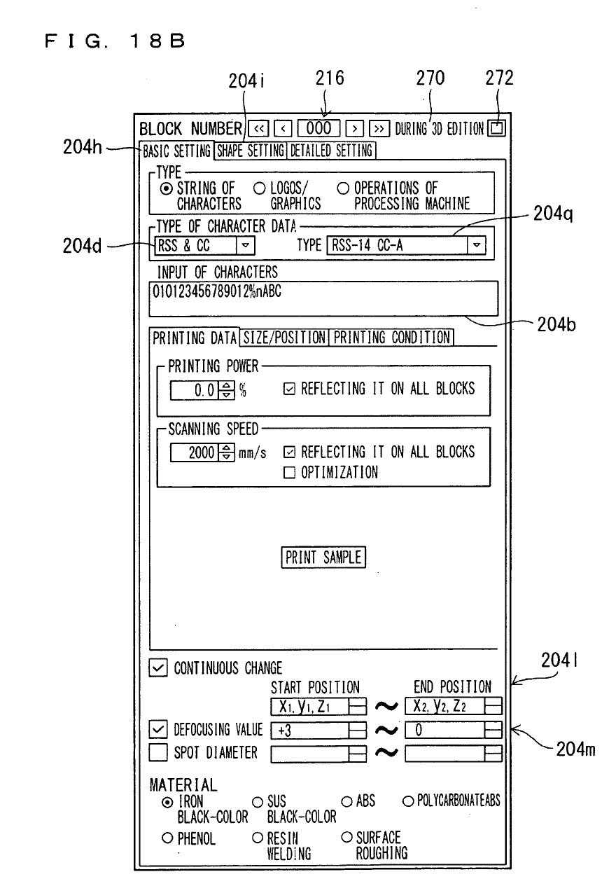

FIGS. 18A and 18B illustrate an example of the processing-parameter setting field 204l for setting a continuous change of laser processing as described above. In the example of FIG. 18B, if a check box in the field of “Performing Continuous Change” provided in the processing-parameter setting field 204l is set to ON, the screen page is changed over to a screen page for setting a continuous change. In this case, the range over which the continuous change is to be performed is specified with coordinate positions. Further, if check boxes for setting items which are desired to be changed are set to ON, input fields for the ranges are displayed, thereby enabling specification of numerical values. In the example of FIG. 18B, the check box for the amount of defocusing is selected, and a defocusing setting field 204m is displayed, thereby enabling specification of an amount of defocusing at the start position and an amount of defocusing at the end position. The specified amount of defocusing is automatically set such that it is changed continuously and evenly within the specified range. Also, only an initial value or an end value can be specified and, also, an amount of increase or decrease or a rate of change can be specified. Further, if amounts of defocusing are set, a reference is made to the reference table 5B for searching for corresponding numerical values for the fields of the spot diameter, and these numerical values are automatically inputted to the input fields. As described above, if any of the setting items is specified, values corresponding thereto are automatically inputted to the other setting items, which enables the user to change the processing conditions to desired processing conditions only by setting the necessary items, without being aware of the correlation among the processing parameters for the respective setting items.

As described above, the beam diameter of the laser light can be arbitrarily changed depending on the setting items such as the material of the to-be-processed work, the processing pattern, the finishing state and the processing time and, therefore, the beam diameter of the laser light can be changed easily within a short time.

### (Saving and Reading of Settings)

Further, once processing parameters for processing conditions have been set, the processing parameters can be stored as setting data and can be called up, as required. For example, by selecting “Saving with a New File Name” from the file menu, then arbitrarily naming setting information and saving it, it is possible to enable calling up the stored setting data when the same processing will be performed on the same work in the future, which can largely reduce the time and the burden required for preparations. Further, frequently-used settings can be preliminarily registered, which enables even beginners to easily set processing conditions using it. Further, by adjusting the settings based on the setting conditions in the registered or saved data, it is possible to largely reduce the burden for making settings. As described above, setting information can be reused, which can also contribute to reduction of setting operations.

As described above, the flow of the method for setting laser processing data using the laser-processing-data setting program is basically includes procedures for setting a string of characters to be printed and a layout as two-dimensional printing pattern information using two-dimensional setting user interfaces, at first and, then, setting three-dimensional information and a layout for converting the printing pattern into a three-dimensional shape using three-dimensional setting user interfaces. These procedures will be described in detail. At first, as setting through the two-dimensional setting user interfaces, information defining a string of characters, a barcode, a two-dimensional code or a user-specified graphic or the like which is to be printed, and data about a planer layout such as a size of the characters and the like, inclinations of the respective characters and a line width are inputted. For inputting the data, it is possible to directly input numerical values or directly edit an image displayed in a two-dimensional manner on the processing-image display portion. For example, the sizes and the layout can be adjusted through mouse operations. These settings can be performed through displaying in a two-dimensional manner.

### (Processing Conditions)

The processing conditions include processing-pattern information indicative of the content of processing and three-dimensional shape information for use in converting the processing pattern into a three-dimensional shape according to the shape of the to-be-processed surface. The processing pattern is image data of a string of characters, symbols such as a barcode or a two-dimensional code, or logos. Further, in a batch processing mode for palette printing and the like, a processing pattern can include variable numbers such as a manufacture date and a serial number. Variable numbers include values which are incremented according to the processing position and the order of processing, such as a serial number, in addition to a processing date, a predetermined value specified at the time of processing. By adding the information to the work as described above, it is possible to realize three-dimensional printing according to the traceability.

The processing conditions which have been set using the laser-processing-condition setting program and the laser-processing-condition setting device as described above are held in the storage portion 5A (FIG. 11). After the processing conditions are set, the processing conditions are transferred to the memory portion 5 (FIG. 1) in the controller 1A and decompressed therein. References are made to the processing conditions during processing operations.

### (Function of Correcting Thermal Lens Effects)

Further, the laser marker has a thermal-lens-effect correction function for correcting the deviation of the focus position caused by thermal lens effects, with a focus-position adjustment section capable of adjusting the focus position of the laser light in the direction of the optical axis. More specifically, the amount-of-correction identification section 80B identifies an amount of focus-position correction for correcting thermal lens effects which will be induced, from the processing conditions set by the processing-condition setting portion 3C. Then, according to the amount of focus-position correction, the laser driving control portion controls the Z-axis scanner, in such a way as to adjust the focus position for scanning the laser light. This can realize laser processing with higher reliability which can maintain processing with high quality, without degrading the processing quality, even if thermal lens effects are induced. The amount of focus-position correction determined by the amount-of-correction identification section 80B is automatically calculated according to the processing conditions set by the processing-condition setting portion 3C at the time of setting the laser marker. According to the amount of focus-position correction, the laser driving control portion controls the laser-light scanning portion 9, such that processing is performed with the corrected focus position during irradiation of the laser light.

The Z-axis scanner having the function of adjusting the focus position as described above can be also utilized for correcting thermal lens effects in making settings, as well as utilized for three-dimensional processing. Particularly, the correction of thermal lens effects has conventionally required manually adjusting the working distance of the laser marker on the scene according to the deviation of the focus position caused by thermal lens effects, which has involved extremely burdensome operations. Furthermore, if the laser processing conditions such as the laser power and the frequency of the Q switch are changed, the degree of the deviation of the focus position is also changed, which has required making settings again and again for coping therewith. Further, although there are many laser markers adapted to enable changing the processing conditions such as the laser power and the frequency of the Q switch for each processing block, the change of the processing conditions also causes changes of the degree of thermal lens effects and, therefore, when the laser light is continuously directed to the plurality of processing blocks, it is impossible to adjust the focus position accurately for all the processing blocks, thereby resulting in non-uniformity of processing quality over the processing blocks. According to the present embodiment, the adjustment of the processing positions can be varied for the respective processing blocks, which can overcome the above problem, thereby realizing extremely-high-quality processing.

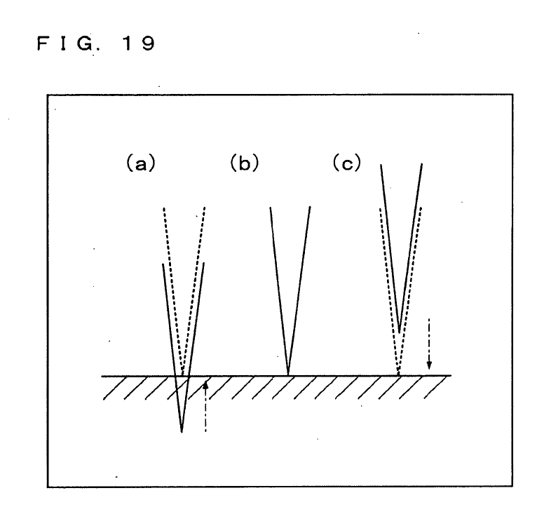

Hereinafter, with reference to FIG. 19, the function of correcting thermal lens effects will be described. FIG. 19 illustrates states where the focus position is changed due to thermal lens effects, wherein FIG. 19 (a) illustrates a state where the focal distance is extended as illustrated by a solid line when the laser power is larger or the frequency of the Q switch is smaller, while FIG. 19 (c) illustrates a state where the focal distance is shortened as illustrated by a solid line when the laser power is smaller or the frequency of the Q switch is larger with respect to FIG. 19 (b).

For example, solid lasers such as YVO₄ lasers and YAG lasers induce thermal lens effects, thereby inducing the phenomenon of deviations of the focus position from the original position, when the solid laser mediums are heated. The amount of deviation of the focus position is proportional to the amount of heat retained within the laser oscillator. This is equivalent to (the input power) minus (the laser average output), and the input power is a laser power set value, and the laser average output is a function of the Q-switch frequency. Accordingly, the amount of deviation of the focus position ΔVspot can be expressed as Δvspot=f (P, Q). In this case, P is the power set value, and Q is a parameter relating to the Q switch (the Q-switch frequency, the ON/OFF duty, or the like).

On the other hand, the laser marker incorporates the Z-axis scanner as the laser-light scanning portion 9 which is capable of adjusting the focus position in the direction of the optical axis. Thus, control is performed such that the amount of deviation is offset, using the Z-axis scanner. For example, as illustrated by the solid line in FIG. 19 (a), when the laser power is larger, the frequency of the Q switch is smaller or the ON/OFF duty ratio is larger, the focus position is changed to be more distant. Accordingly, in order to correct this, as illustrated by a broken line in FIG. 19 (a), the focus position is adjusted by controlling the Z-axis scanner, such that the focus position becomes closer to the laser processing apparatus, namely the spot diameter becomes smaller. On the contrary, when the laser power is smaller, the frequency of the Q switch is larger or the ON/OFF duty ratio is smaller, the focus distance becomes smaller, as illustrated by the solid line in FIG. 19 (c). Accordingly, as illustrated by a broken line in FIG. 19 (c), the Z-axis scanner is controlled, such that the focus position becomes closer to the to-be-processed surface, namely the spot diameter becomes larger.

Further, thermal lens effects can also be induced in the wavelength changeover device made of LBO or the like, not in the laser oscillation portion itself, similarly to in the solid laser medium. Therefore, the function of correcting thermal lens effects is effective. Further, depending on the intensity of the beam passed through the inside of the wavelength changeover device, the wavelength changeover device changes the beam divergence angle. Accordingly, the Z-axis scanner as the focus-position adjustment section can be also utilized for correcting the change of the beam divergence angle.

Further, similarly, in laser processing apparatuses which employ no solid laser mediums, such as CO₂ lasers, if optical devices such as external lenses are heated by the power of the laser beam passed therethrough, the focus position can be changed due to the thermal expansions, distortions and the like of the optical devices. In this case, similarly, the Z-axis scanner as the focus-position adjustment section can be utilized for corrections.

### (Time Interval of Transition to Thermal Equilibrium State)

Further, there may be possibly designs which require a long time interval for bringing thermal lens effects into a thermal equilibrium state, after the laser power and the frequency of the Q switch are changed. For example, there may be possibly cases where the solid laser medium is larger, and the solid laser medium is in contact with a member with a larger thermal capacity. In this case, the amount of focus-position correction can be dynamically changed, which enables proper corrections even during the transient time interval. For example, the amount of focus-position correction can be expressed as Δvspot=f″ (P, Q, t) (t: time) in consideration of the time change.

Further, there may be possibly cases where the degree of thermal lens effects is varied depending on individual solid laser mediums. In this case, the coefficients and the constant values in the function f″ (P, Q, t) can be adjusted and corrected depending on individual solid laser mediums. In addition, the amount of focus-position correction can be adjusted in consideration of the temporal change.

### (Superimposition of Amount of Defocusing)

Further, the laser marker including the Z-axis scanner and being capable of three-dimensional processing has a defocusing function for purposely deviating the focus position for performing processing, as described above. Specifically, the user can change the spot position in the direction of the optical axis for each processing block, using the processing-condition setting portion 3C, namely the defocusing setting field 204 m in FIG. 18B, for increasing the spot diameter for boldface-type printing or for decreasing the spot diameter for lightface-type printing. In this case, similarly, control is performed, in such a way as to take account of the amount of focus-position correction. More specifically, assuming that the spot position desired by the user is ΔYspot, control is performed, by setting, as the focus position, the value of ΔYspot+ΔVspot obtained by adding the value of ΔYspot to the amount of focus-position correction. As described above, in cases where defocusing has been set, the focus-position adjustment section is controlled in such a way as to offset the amount of defocusing, thereby realizing proper processing.

### (Control of Amount of Delay According to Focus Position)

Also, control can be performed in such a way as to change the above-described delay operation according to the amount of adjustment of the focus position. In cases where the processing conditions are changed for each processing block as described above, the Z-axis scanner is operated for each processing block. In this case, the amount of the movement of the Z-axis scanner depends on the processing pattern for the previous processing block and on the amount of focus-position correction. Accordingly, control can be performed such that the amount of delay, namely the delay time, is changed in consideration of the difference between adjacent processing blocks, which enables proper delay operations according to the actual amount of the movement of the Z-axis scanner.

### (Amount-of-Correction Identification Section 80B)

Next, there will be described procedures with which the amount-of-correction identification section 80B determines an amount of focus-position correction in the direction of the optical axis for coping with thermal lens effects. The amount of focus-position correction can be easily identified, by making a reference to a reference table as an aspect of an amount-of-correction storage section which has preliminarily stored amounts of deviations due to thermal lens effects, namely amounts of focus-position correction, in association with laser processing conditions. The amount-of correction storage section has preliminarily stored, as two-dimensionally-arranged table data, focus-position information corresponding to the laser-light outputting condition set by the processing-condition setting portion 3C, such as the parameter values such as the laser power, the frequency of the Q switch, the ON/OFF duty ratio, and the amount-of-correction identification section 80B can read, therefrom, an amount of focus-position correction corresponding to parameter values. This can reduce the load of the processing by the amount-of-correction identification section 80B, thereby realizing speed-up.

Also, an amount of focus-position correction can be determined through calculations, based on the set laser processing condition, without using a table. In this case, a calculation equation for calculating the amount of deviation of the focus position caused by thermal lens effects induced depending on the laser-light outputting condition has been preliminarily set in the amount-of-correction identification section 80B, and the amount-of-correction identification section 80B calculates an amount of focus-position correction for each laser processing condition, based on the calculation equation. With this method, it is possible to properly determine an amount of focus-position correction, without using a storage device for a table and the like. Also, a plurality of calculation equations can be prepared such that any of them can be used by switching among them. As a calculation equation, it is possible to set Δvspot=aP−f (Q)+c (a, b and c are constant values; P is the laser power; Q is a parameter relating to the Q switch (the frequency of the Q switch, the ON/OFF duty ratio or the like). By using the calculation equation, it is possible to calculate ΔVspot according to the changes of the parameter values P and Q, and, based on the value, it is possible to control the Z-axis scanner in a real time manner such that the focus is coincident with the work.

Further, in any of the cases, the amount-of-correction storage section and the amount-of-correction identification section can be placed in the controller 1A. For example, amounts of focus-position correction can be held in the decompressed-information memory 5c provided in the memory portion 5 in FIG. 1 such that references can be made thereto during processing.

### (Flow of Processing-Condition Setting Data)

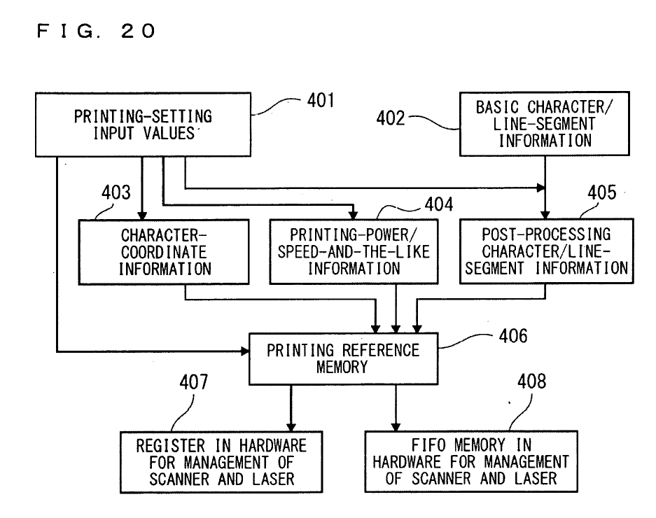

FIG. 20 illustrates a block diagram illustrating the flow of data during processing from user's inputting of settings of processing conditions to the start of processing. In FIG. 20, printing-setting input values 401 correspond to setting information about processing conditions which have been set by the processing-condition setting portion 3C in FIG. 11 and the like and then stored in the storage portion 5A. In this case, the user inputs a laser power, a Q-switch frequency, an amount of defocusing ΔYspot, and the like to the screen page of FIGS. 14A and 14B. Further, basic character/line-segment information 402 is information stored in the basic-character/line-segment information memory 5b in FIG. 1. From these information, character-coordinate information 403, printing-power/speed-and-the-like information 404 and post-processing character/line-segment information 405 are created through decompression processing. The decompressed information including these information is stored in a printing reference memory 406 corresponding to the decompressed-information memory 5c in FIG. 1. Then, the decompressed information stored in the printing reference memory 406 is transferred to a register 407 and a FIFO memory 408 in the controller portion, in response to a command for start of printing.

### (Procedures for Determining Amount of Focus-Position Correction)

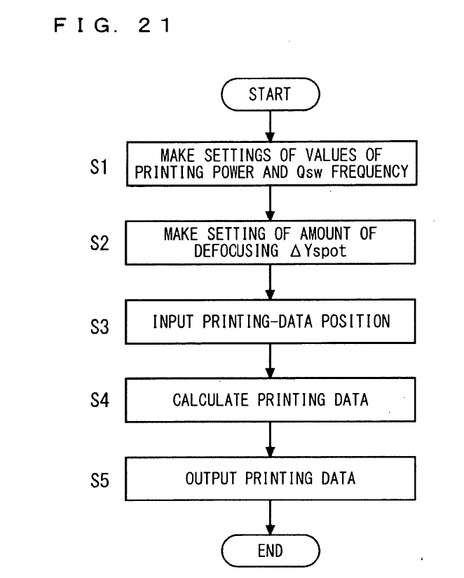

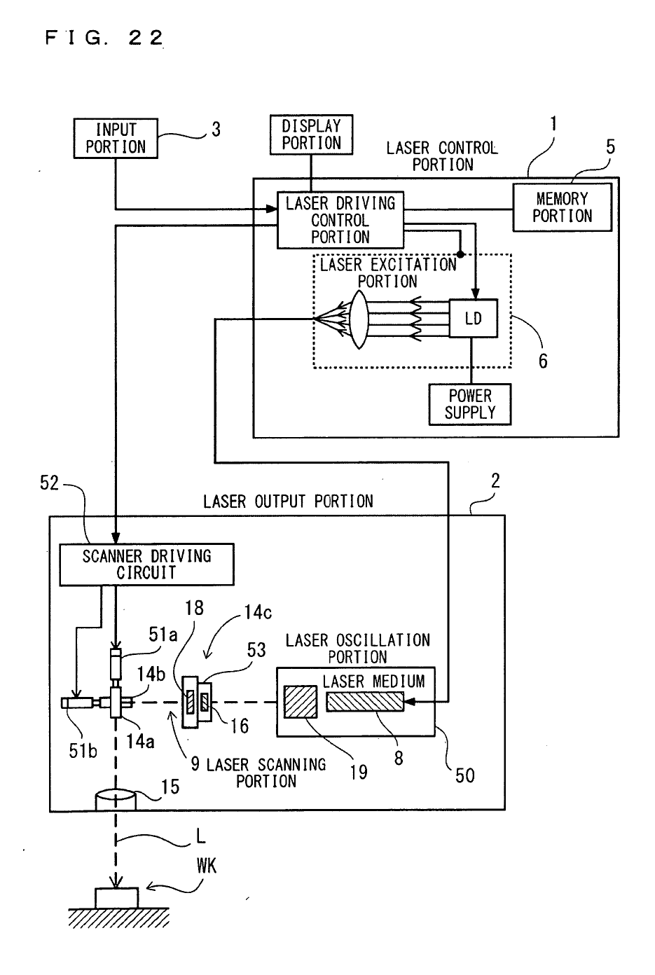

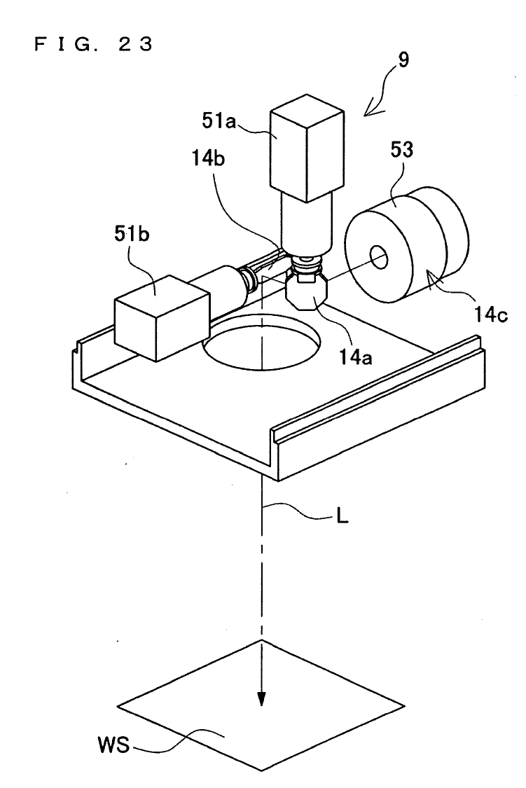

Next, with reference to a flow chart of FIG. 21, there will be described procedures for determining an amount of focus-position correction to be supplied to the Z-axis scanner. At first, in step S1, processing conditions are set. More specifically, the user sets, through the processing-condition setting portion 5C, a laser power to be emitted from the Q switch 19, the frequency of the Q switch, and the ON/OFF duty ratio of the Q switch, as laser-light outputting conditions. Further, as required, an amount of defocusing ΔYspot is set in step S2. Then, processing-pattern position information is set in step S3. Accordingly, the XYZ coordinates of the processing position are determined. In addition thereto, setting information including system information, setting common information and block information is inputted. After the setting information is inputted as described above, processing data is calculated in step S4. In this phase, the amount-of-correction identification section 80B takes account of an amount of focus-position correction, and the final Z-coordinate position Z=z (x,y)+Δyspot+f (P, Q) is determined. Further, processing for decompressing the printing information is performed to determine the order of printing. At this time, the character-coordinate information 403, the printing-power/speed-and-the-like information 404 and the post-processing character/line-segment information 405 illustrated in FIG. 20 are created. More specifically, processing for expanding or contracting the characters defined by the basic-character/line-segment information, adding run-up line segments and thickening lines (as required) is performed, according to the character size, the run-up length and the thick-line width which have been inputted by the user. The decompressed information created as described above is temporarily stored in the printing reference memory 406 (the decompressed-information memory 5c). Thereafter, user's inputting of a command for start of printing is waited for.

If a command for execution of printing is inputted, printing data is outputted in step S5 and, then, printing processing is executed. In this case, updated characters indicative of time, date, a rank and the like are determined as required and, thereafter, the decompressed information is transferred to the register 407 and the FIFO memory 408. In cases where the content of printing includes no updated characters, the decompressed information read from the printing reference memory 406 is directly transferred to the register 407 and the FIFO memory 408. The updated characters are to-be-printed characters indicative of time, date, a rank, a serial number and the like. This case corresponds to a case where a serial number is printed to each of the plurality of works such that it is incremented one by one. When there are updated characters, the user clearly specifies the presence of the updated characters at the time of inputting for setting the processing condition, and decompressing processing is performed on all of the characters which are likely to be used in printing (for example, numbers of 0 to 9). The time and the time limit of printing are calculated at the time when a command for start of printing is inputted. As described above, after the decompressed information is transferred to the register 407 and the FIFO memory 408, printing is started. More specifically, when the decompression information has been accumulated in the register 407 and the FIFO memory 408 or when the free space in the FIFO memory 408 has been run out, a command for start of printing the content of the hardware is issued, and printing is started. When the free space in the FIFO memory 408 has been run out, if there is a remaining part of the decompressed information, the transferring of the decompressed information is temporarily stopped and, at the time when the free space of the FIFO memory 408 has increased to the half the space of the FIFO memory 408 along with the execution of printing, the transferring of the decompressed information is started again.

As described above, in the present embodiment, the existing Z-axis scanner is utilized for controlling the focus position for correcting thermal lens effects, and the like. Accordingly, the present embodiment can be realized with an inexperience and simple structure. Particularly, when it is desired to change the processing conditions for respective processing blocks, the present embodiment is extremely effective.

The laser processing apparatus, the laser processing method and the method for making settings for the laser processing apparatus according to the present invention can be widely applied to processing for applying laser to a stereoscopic surface having a stereoscopic shape, such as marking, drilling, trimming, scribing, surface processing. Further, while there has been exemplified a laser marker capable of printing in a three-dimensional manner, the present invention can be preferably applied to laser markers capable of printing in a two-dimensional manner.

What is claimed is:

1. A laser processing apparatus capable of directing laser light to a to-be-processed surface for performing processing in a desired processing pattern, the laser processing apparatus comprising:
a laser oscillation portion for generating laser light;
a laser-light scanning portion for scanning the laser light emitted from the laser oscillation portion within a work area, the laser-light scanning portion comprising a Z-axis scanner comprising an incidence lens and an emission lens and being capable of changing the distance between the incidence lens and the emission lens along their optical axis for adjusting the focus position of the laser light in the direction of the optical axis at a state where the optical axes of the incidence lens and the emission lens are coincident with the optical axis of the laser light emitted from the laser oscillation portion, and an X-axis scanner and a Y-axis scanner for scanning the laser light passed through the Z-axis scanner in the direction of the X axis and in the direction of the Y axis;
a laser driving control portion for controlling the laser oscillation portion and the laser-light scanning portion;
a processing-condition setting portion for setting a laser-light outputting condition and a processing pattern, as processing conditions for processing in a desired processing pattern; and
an amount-of-correction identification section for identifying, as an amount of focus-position correction, the deviation of the focus position in the direction of the optical axis which is caused by thermal lens effects induced depending on the laser-light outputting condition set by the processing-condition setting portion;
wherein, during irradiation of the laser light, the laser driving control portion causes scanning of the laser light, in such a way as to add the amount of focus-position correction identified by the amount-of-correction identification section to the processing conditions set by the processing-condition setting portion.

2. The laser processing apparatus according to claim 1, further comprising a Q switch for causing pulsed oscillation of the laser light,
wherein the processing-condition setting portion is capable of setting at least one of the laser power, the frequency of the Q switch, and the ON/OFF duty ratio of the Q switch, as a laser-light outputting condition,
the amount-of-correction identification section determines that the focal distance is increased and, thus, sets an amount of focus-position correction in the direction of the optical axis for coping with thermal lens effects in such a direction as to make the focus position closer when the processing-condition setting portion makes settings in a direction such that the laser power is increased, the frequency of the Q switch is decreased or the ON/OFF duty ratio is increased, and
the amount-of-correction identification section determines that the focal distance is decreased and, thus, sets an amount of focus-position correction in such a direction as to make the focus position more distant, when the processing-condition setting portion makes settings in a direction such that the laser power is decreased, the frequency of the Q switch is increased or the ON/OFF duty ratio is decreased.

3. The laser processing apparatus according to claim 1, further comprising
an amount-of-correction storage section for preliminarily storing amounts of focus-position correction in the direction of the optical axis for coping with thermal lens effects, in association with laser-light outputting conditions,
wherein the amount-of-correction identification section identifies an amount of focus-position correction corresponding to the set laser-light outputting condition, by reading it from the amount-of-correction storage section.

4. The laser processing apparatus according to claim 1, wherein
the amount-of-correction identification section identifies an amount of focus-position correction in the direction of the optical axis for coping with thermal lens effects, through calculations based on a preset calculation equation.

5. The laser processing apparatus according to claim 1, wherein
the processing-condition setting portion is capable of setting an amount of defocusing by which the focus position of the laser light is purposely deviated, and
the amount-of-correction identification section identifies an amount of focus-position correction in the direction of the optical axis for coping with thermal lens effects, based on the set amount of defocusing.

6. The laser processing apparatus according to claim 1, wherein
the processing-condition setting portion is capable of setting one or more three-dimensional processing patterns for a to-be-processing surface in association with different conditions, as processing conditions.

7. The laser processing apparatus according to claim 6, wherein
in processing with a plurality of different patterns, the laser driving control portion is capable of setting a delay time for delaying the start of outputting of the laser light, after a command for an operation is generated to the Z-axis scanner until the Z-axis scanner will have completed the operation commanded by the command for the operation, based on the laser-light outputting condition and/or the processing patterns.

8. The laser processing apparatus according to claim 1, wherein
when the plurality of processing patterns are set in association with different processing conditions, the laser driving control portion adjusts the delay time, according to the previous processing pattern and the amount of focus-position correction for the previous processing pattern.

9. The laser processing apparatus according to claim 5, wherein
the processing conditions set by the processing-condition setting portion include a parameter relating to the elapsed time, and
the amount-of-correction identification section identifies an amount of focus-position correction based on the parameter relating to the elapsed time.

10. A laser processing apparatus capable of directing laser light to a to-be-processed surface for performing processing in a desired processing pattern, the laser processing apparatus comprising:
a light source;
a laser medium which is placed in a resonator for laser light and is excited by the light-source light from the light source to generate laser light;
a Q switch which is placed on the optical axis of the laser light emitted from the laser medium within the resonator for causing pulsed oscillation of the laser light;
a focus-position adjustment section capable of adjusting the focus position of the laser light emitted from the Q switch in the direction of the optical axis;
a laser-light two-dimensional scanning system for scanning, in a two-dimensional manner, the laser light emitted from the focus-position adjustment section;
a processing-condition setting portion for setting at least one of the power of the laser light emitted from the Q switch, the frequency of the Q switch and the ON/OFF duty ratio of the Q switch;
an amount-of-correction identification section for identifying, as an amount of focus-position correction, the deviation of the focus position in the direction of the optical axis which is caused by induced thermal lens effects, based on the settings made by the processing-condition setting portion; and
a laser driving control portion for controlling the focus-position adjustment section in such a way as to adjust the focus position, based on the amount of focus-position correction identified by the amount-of-correction identification section.

11. A laser processing method for directing laser light to a to-be-processed surface for performing processing in a desired processing pattern, the laser processing method comprising the steps of
setting a processing pattern and a laser-light outputting condition including at least one of the power of the laser light emitted from the Q switch, the frequency of the Q switch and the ON/OFF duty ratio of the Q switch, as processing conditions for processing in a desired processing pattern;
identifying, as an amount of focus-position correction, the deviation of the focus position in the direction of the optical axis which is caused by induced thermal lens effects, based on the laser-light outputting condition which has been set; and
performing processing through irradiation of the laser light based on the laser-light outputting condition and the processing pattern which have been set, while adjusting the focus position of the laser light emitted from the Q switch in the direction of the optical axis, based on the identified amount of focus-position correction.

12. A method for making settings for laser processing apparatus for directing laser light to a to-be-processed surface for performing processing in a desired processing pattern, the method comprising the steps of
setting a processing pattern and a laser-light outputting condition including at least one of the power of the laser light emitted from the Q switch, the frequency of the Q switch and the ON/OFF duty ratio of the Q switch, as processing conditions for processing into a desired processing pattern; and
identifying the deviation of the focus position in the direction of the optical axis which is caused by induced thermal lens effects based on the set laser-light outputting condition, and setting the focus position corresponding to the processing pattern in such a way as to correct the focus position using the deviation of the focus position as an amount of focus-position correction, at the time of processing.
